(19) United States
(12) Patent Application Publication
(10) Pub. No.: US 2008/0065359 A1
(43) Pub. Date: Mar. 13, 2008

(54) Methods and Apparati for Efficiently Parametrizing, Describing, Generating, Modifying and Manipulating Configurations, Conformations, and Deformations of Systems That Comprise Multiple Physical or Virtual Objects

(76) Inventors: Lee Norman Rudolph, Westport, MA (US); Li Han, Worcester, MA (US)

Correspondence Address: Lee N. Rudolph, Box 251, Adamsville, RI, 02801-0251, US

(21) Appl. No.: 11/778,050

(22) Filed: Jul. 15, 2007

Related U.S. Application Data
(60) Provisional application No. 60/831,096, filed on Jul. 15, 2006.
(60) Provisional application No. 60/835,226, filed on Aug. 2, 2006.

(51) Int. Cl. G06F 7/60

(52) U.S. Cl. 703/2

(57) ABSTRACT

Multi-object systems include such concrete, practical objects as robot hands, arms, and platforms; protein, polymer, and other complex molecules; and complex graphic displays. Multi-point systems are idealized mathematical constructs that model multi-object systems. Many natural, practical, and important problems involving such models have proven to be computationally expensive or intractible with the prior art. This invention provides new and highly efficient methods and apparati for generating, modifying, manipulating, and otherwise working with multi-point systems, including new parameters to describe configurations, conformations, and deformations of such systems.

### CROSS-REFERENCE TO RELATED APPLICATIONS

This application claims the benefit of provisional patent application Ser. No. 60/831,096, filed 2006 Jul. 15 by the present inventors, and provisional patent application Ser. No. 60/835,226, filed 2006 Aug. 2 by the present inventors.

### FEDERALLY SPONSORED RESEARCH

Not Applicable

### SEQUENCE LISTING OR PROGRAM

Not Applicable

### BACKGROUND OF THE INVENTION FIELD OF INVENTION

This invention relates to multi-point and multi-object systems, including but not limited to such systems as robot hands, arms, and platforms; protein, polymer, and other complex molecules; and complex graphic displays.

### BACKGROUND OF THE INVENTION PRIOR ART

To put the prior art in context it is necessary to spend some time describing and defining certain technical concepts and terminology.

Multi-Point and Multi-Object Systems

A multi-point system is an idealized mathematical construct. Such a system comprises one or more mathematical points. In a given multi-point system, the points all belong to one and the same mathematical space, and are positioned subject to mathematical constraints characteristic of the given system. These constraints can take the form of equations or of inequalities.

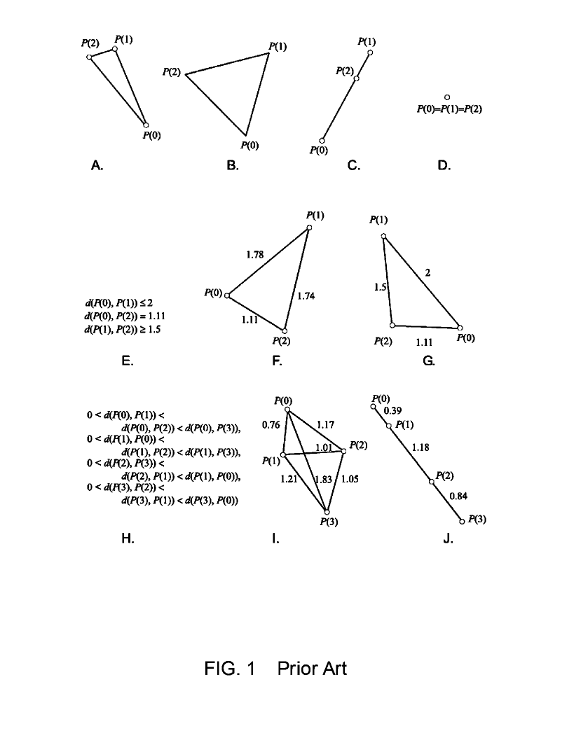

Examples. (1) The mathematical construct commonly known as a “triangle” is a 3-point system. Its 3 points all belong to one and the same Cartesian space, with relative positions subject to no further constraints. See FIG. 1A. (2) An “equilateral triangle” is another 3-point system. It comprises 3 points P, Q, and R in Cartesian space. In words, the characteristic constraints of the system are that all three sides have the same length. Formally, the constraints are the mathematical equations length(P,Q)=length(P,R), length(P,Q)=length(Q,R), and length(P,R)=length(Q,R). (These 3 restraints are redundant: any two imply the third.) See FIG. 1B.

A multi-object system is a physical or virtual construct. Such a system comprises one or more objects. In a given multi-object system, the objects all are contained in one and the same space. The space and the objects in a given multi-object system may be physical or they may be virtual. The positions and orientations of the objects are subject to constraints characteristic of the given system.

Examples. (3) A given water molecule is a 3-object system in physical space. The molecule comprises one oxygen atom O and two hydrogen atoms H. The atoms are subject to constraints on the lengths of bonds O-H and on the angle between the two bonds. These constraints are empirically and theoretically determined by physical chemistry. (4) A given protein molecule is a multi-object system in physical space. In fact, it is a multi-object system in several different ways, at different scales. For instance, the objects can be taken to be atoms, or to be amino acids. The constraints on this multi-object system are empirically and theoretically determined by biochemistry; they comprise various restrictions on lengths and angles. (5) A human hand is a multi-object system in physical space. As in example (4), analysis of the hand at different scales leads to different multi-object systems, with different objects and different constraints. At one scale, the objects are the bones, joints, muscles, and tendons, with constraints determined by gross anatomy. (6) A robot hand, arm, or platform is also a multi-object system in physical space, in different ways at different scales. At one scale of analysis used by many theoretical roboticists, its constraints are determined by geometry alone; at other scales, further constraints are determined by mechanical engineering, materials science, etc. (7) In psychometrics and econometrics, Multidimensional Scaling (MDS) algorithms are used to visualize structure in large datasets. The input for such an algorithm is a square array: N items A, B, . . . , Z in a database are compared in pairs, yielding numerical measures m(A,B), . . . , m(Y,Z) of their similarity. Such a square array is equivalent to an N-object system in virtual space. The output of an MDS algorithm is a related, more easily visualized, N-object system in virtual space of a lower dimension. (8) Computer graphics and animation provide many examples of multi-object systems in virtual space. The objects comprised by such a system can be simple, like points, lines, or circles. They can also be very complicated, like depictions of faces, bodies, or landscape elements. Some characteristic constraints of a given such system can be very simple: e.g., a given point must lie on a given line or be inside a given circle. Other characteristic constraints of a given such system can be very complicated: e.g., an animation of a general moving body must appear to obey certain physical laws; an animation of a particular character must move with a certain gait.

Configurations of Multi-Point and Multi-Object Systems

A configuration of a given multi-point or multi-object system is any specific collection of points or objects satisfying the system's characteristic constraints. (Note that chemists and structural biologists normally use the word “conformation” for what we call a configuration. Our usage is standard in robotics and mathematics, and we shall use it throughout this patent application.)

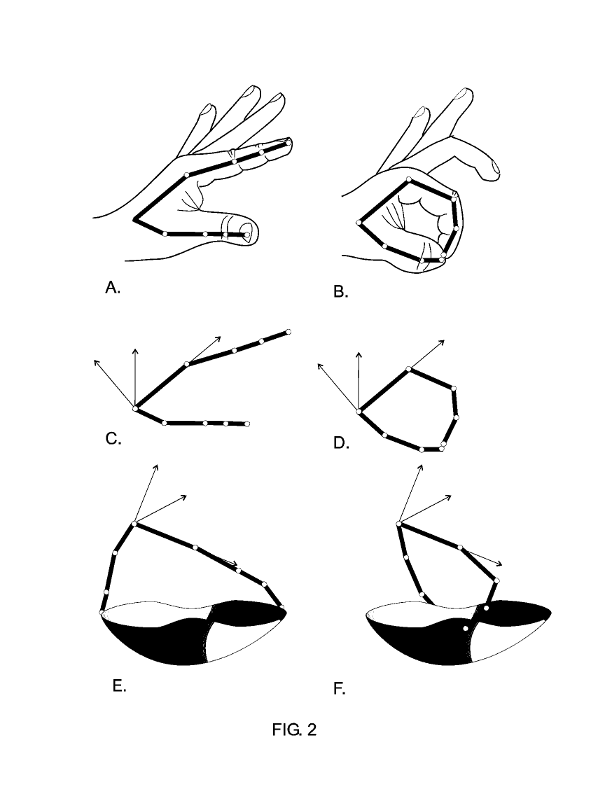

Examples. (1, continued) Each specific triangle in Cartesian space is one configuration of the “triangle” 3-point system. (2, continued) Each specific equilateral triangle in Cartesian space is one configuration of the “equilateral triangle” 3-point system. (3, continued) Each specific arrangement of a particular water molecule in physical space is one configuration of the “water molecule” 3-object system. (4, continued) Each specific arrangement of a particular molecule of some given kind of protein in physical space is one configuration of a multi-object system. (5, continued) Each specific arrangement of a particular human hand in physical space is one configuration of a multi-object system. FIGS. 2A and 2B depict two configurations of one particular human hand.

Note that a configuration of a multi-object system is specified by both the positions and the orientations of the objects; system constraints in a multi-object system take account of object orientations.

For analysis and control, multi-object systems are often described, or modeled, by multi-point systems. Such a model facilitates the application of mathematical and computer methods. Configurations of the multi-object system are mapped by configurations of the multi-point system. Then mathematical and computer algorithms, procedures, and transformations are applied to the multi-point system. By such means, potential or actual manipulations of the mapped multi-object system can be analyzed, planned, and otherwise studied, and apparati can be constructed to control or depict the multi-object system in physical or virtual space.

Examples. (1, continued) FIG. 1E is a description, in mathematical inequalities imposed on distances, of a particular 3-point system. The description, put in words, would read: “a triangle with one edge at most 2 units in length, a second edge exactly 1.11 units in length, and a third edge at least at least 1.5 units in length”. FIGS. 1F and 2G depict two configurations of this system. (5, continued) FIGS. 1C and 2D depict two configurations of a 9-point system modeling a multi-object system. The multi-object system represents the thumb and finger of a human hand. (6, continued) FIG. 1H is a description, in mathematical inequalities, of a particular 4-object system. This system is of the type used for input to MDS algorithms. FIGS. 1I and 1J depict two particular configurations of a 4-point model of that system. Each object in the 4-object system is represented by a point. The relative degrees of similarity of the objects are represented by relative distances between points.

The configuration space of a given multi-point or multi-object system is the collection of all its configurations. Configuration space is often abbreviated to CSpace. For every system, CSpace is a mathematical space. For many systems of practical interest, CSpace is of very large dimensionality (e.g., tens of thousands for a protein molecule). Very often CSpace is also complicated geometrically and topologically. The dimensionality of CSpace reflects the number of independent degrees of freedom of the system. The geometric and topological complication of CSpace reflects complicated interactions among characteristic constraints of the system. Even systems for which the dimensionality of CSpace is not large can have extremely complicated geometry and topology.

When a given configuration of a multi-point or multi-body system is moved as a whole, by a rigid motion, to another configuration, the two configurations are said to represent the same deformation of the system. In this case, although the location and orientation of the system as a whole has changed, the relative positions and orientations of the points or bodies it comprises do not change. Translations and rotations are the basic types of rigid motions.

The collection of all deformations of a system is called its deformation space. It is denoted DSpace. Like CSpace, DSpace is a mathematical space. Mathematically, DSpace is the quotient space of CSpace modulo the group of rigid motions. DSpace always has a slightly smaller dimension than CSpace. The geometry and topology of DSpace and CSpace are closely related, but often DSpace is somewhat simpler.

Parameters for a Point

To study the deformations and configurations of a multi-point system, we need parameters for specifying and determining point positions. Many different sets of coordinates (or parameters) can be used to specify the position of a point. These coordinate systems are mathematically equivalent, so they can be converted from one to another.

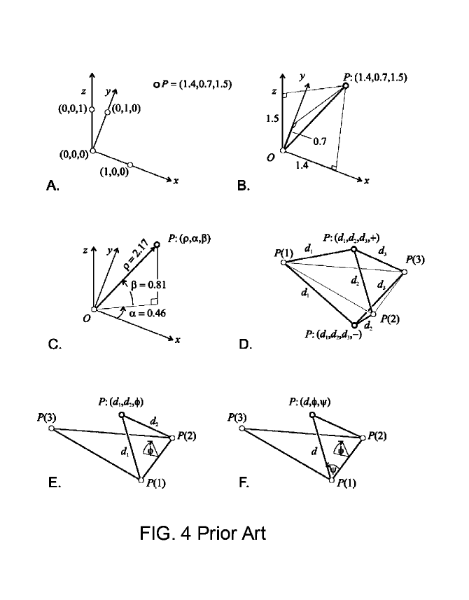

One category of parameters specifies the location of a point by using a coordinate frame.
Cartesian coordinates of the point P with respect to a frame are (Px, Py, Pz), where Px, Py, Pz are the projections of P onto the x, y, z axes of the frame, as shown in FIG. 4A-B.
Spherical coordinates of the point P with respect to a frame are (ρ, α, β), where ρ is the distance between P and the frame origin O, αε(−π, π] is the (radian measure of the) angle between x axis and the projection of the vector O̅P̅ onto the xy plane, and βε (−π/2, π/2] is the angle between O̅P̅ and the xy plane, as shown in FIG. 4C. The angles α and β are spherical angles. There are other ways to define spherical angle coordinates, for example by using a different axis or plane, but they are defined in the same spirit. We will use the spherical angles described above to illustrate the properties of these parameters.

Another category of parameters specifies the location of a point by using geometric information about its relation to three known points (basepoints) of known positions. In the following description, the basepoints are P(1), P(2), and P(3). (The basepoints must not be collinear.)
Distance parameter and sign parameters of P are (d1, d2, d3, e), as shown in FIG. 4D. Here di≧0 is the distance between P and P(i) (i=1, 2, 3), and ε is a sign in {+, −} (or sometimes in ε ε {+, 0, −}). The locations of the basepoints and the distance information (d1, d2, d3) generally define two tetrahedra that have the same shape and share one face (the triangle formed by the basepoints). The fourth vertex of one of these tetrahedra is the mirror image of the fourth vertex of the other, across the plane of the base points. The sign parameter ε picks out one of these vertices.
Adjacent triangle parameters of P are (d1, d2, φ), as shown in FIG. 4E. Here d1 is the distance between P and P(1), d2 is the distance between P and P(2), and φ is the torsional or dihedral angle between the triangle with vertices P(3), P(2), P(1) and the triangle with vertices P(2), P(1), P. (Note that these two triangles share a side P(2), P(1).) FIG. 4F. shows a closely related parameter set where d2 is replaced by the face angle ψ.

Each set of parameters above is equivalent to all the others. As a example, here is the formula for converting the spherical coordinates to Cartesian coordinates.
P=O+ρ[cos β cos α cos β sin α sin β]′
where ′ indicates vector transpose.

Some problems and systems restrict the points to a plane. For example, it is (arguably) true that the joints of each human finger stay in one plane at any moment. Of course the plane can change as the base joint of each finger can rotate. However, if we only want to study the relative deformation of the links of a finger, we can model each link as a planar linkage. So we will also solve many problems related to points in the plane and planar linkages in this invention. For a point in the plane, its parameter can be derived from the parameters for a point in space, with some restrictions, such as Pz=0 in its Cartesian coordinate and β=0 in its spherical coordinate. For a planar point, angle α in the spherical coordinate is also called a revolute angle.

Conventional Approaches for Loops

In this patent application, we will focus on a particular type of multi-object systems, namely, those that can be modeled as multi-point systems with loop constraints among the points, and have an additional property to be described soon.

As an example, consider a sequence of n points P(0), . . . , P(n−1), with distance constraint between P(i) and P(i+1), i=0, . . . , n−2. We also impose a distance constraint between P(n−1) and P(0). A pair A, B of points, with the distance d(A, B) between A and B fixed, models a rigid link. Two consecutive pairs A, B and B, C of points, with the distances d(A, B) and d(B, C) fixed and no other constraints, models a joint. The joint is spherical if the points A, B, C lie in 3-space. The joint is revolute if A, B, C lie in the plane. Consequently, our system of n points under distance constraints models a loop with n rigid links connected by spherical joints (if the points are in space) or revolute joints (if the points are in the plane).

For a more general example, instead of fixing a constant distance between A and B, we could require d(A, B) to lie in a fixed interval. Instead of modeling a rigid link, in this case the pair A, B models a prismatic joint with motion in the direction of the link. A system of n points under some constant distance constraints and some interval distance constraints models a loop with some prismatic joints interspersed among spherical or revolute joints.

A different generalization of the multi-point loop is the multi-point open chain, in which we omit the distance constraint between P(n−1) and P(0). (In some fields like robotics such a system is called a serial chain. Also, a loop is sometimes called a closed chain.)

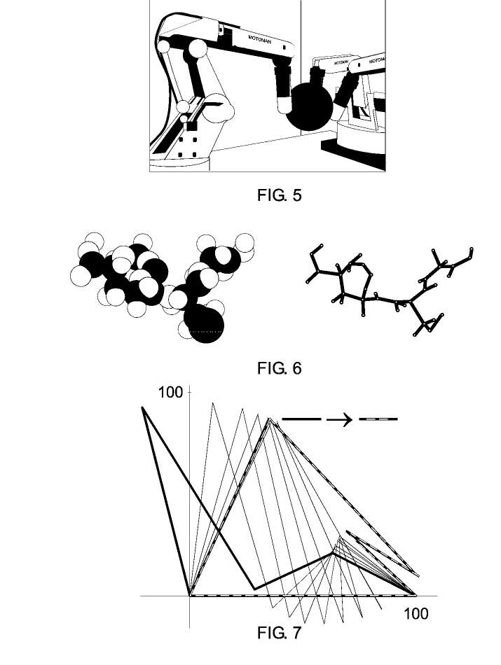

The study of loops is worthwhile because there are many important examples. These include
molecular rings in proteins (see FIG. 6;
grasping systems formed by human hands (FIG. 2B), robotic hands (FIG. 5), or computer animated hands; parellel manipulators such as the Stewart platform;
   and others. In contrast to serial chains, these systems need to maintain loops and satisfy loop closure constraints. Loop closure constraints are very difficult to deal with mathematically and computationally; they lack efficient solutions in the prior art. FIG. 7 illustrates an efficiently generated motion of a loop (path of loops) generated by our invented method.

To demonstrate the complexity of the loop closure constraints from the viewpoint of the prior art, we next show the conventional formulation of these constraints.

First consider using point Cartesian coordinates Pᵢ=[xᵢ, yᵢ, zᵢ]. Before imposing the loop constraints, the set of n points is described by a total of 3n coordinate values (if in space) or 2n coordinate values (if in the plane). To focus on the deformation and not consider rigid motions of the whole loop, we can assume special positions for a few of the points, such as putting P₀ at the origin, P₁ on the positive x axis, and P₂ in the upper XOY half-plane. This reduces the number of degrees of freedom from 3n to 3n−6 (in space) or from 2n to 2n−3 (in the plane). The loop constraints are the n equations
∥PᵢPᵢ₊₁∥=d(i,i+1),i=0, . . . , n−1, (1)
one for each pair of adjacent points in the loop. (Here we write d(i,i+1) for the required distance between Pᵢ and Pᵢ₊₁; and we let n be cyclically identified with 0.) In non-exceptional cases, these n constraints reduce the number of degrees of freedom by exactly n. The result is that DSpace of the loop has dimensionality 2n−6 (in space) or n−3 (in the plane). From this point of view, DSpace is defined by a system of algebraic equations in the Cartesian coordinates. (For example, ∥P₀P₁∥=d(0, 1) expands to {square root over ((x₁−x—₀)²+(y₁−y₀)²+(z₁−z₀)²))}=d(0, 1), or equivalently ((x₁−x₀)²+(y₁−y₀)²+(z₁−z₀)²)=d(0, 1)².) Viewed as an algebraic set, DSpace could be very complicated. One measure of the complication of an algebraic set is its degree; DSpace has degree 2ⁿ, so the potential complication grows exponentially with the number of links in the chain.

Alternatively, we can use spherical coordinates. Of course the number of degrees of freedom is the same as that computed for Cartesian coordinates. To formulate the constraints in spherical coordinates, first note that the position of joint P(j+1) is related to the position of P(j) and the spherical coordinates (α(i), β(i)) as follows.
P(i+1)=P(i)+l(i)[cos β(i)cos α(i)cos β(i)sin α(i)sin β(i)]′ (2)
Now concatenating the formula ((2)) from 0 to j will give the equation relating P(j+1) to P(0).

$$P ( j + 1 ) = P ( 0 ) + {\sum }_{i = 0}^{j} {l ( i ) [ cos β ( i ) cos α ( i ) cos β ( i ) sin α ( i ) sin β ( i ) ]}^{′}$$

Finally, the link closure condition is

$$P ( 0 ) = P ( 0 ) + {\sum }_{i = 0}^{j} {l ( i ) [ cos β ( i ) cos α ( i ) cos β ( i ) sin α ( i ) sin β ( i ) ]}^{′} .$$

This can be simplified by removing P(0) from both sides.

$${0}^{3 \times 1} = {\sum }_{i = 0}^{n - 1} {l ( i ) [ cos β ( i ) cos α ( i ) cos β ( i ) sin α ( i ) sin β ( i ) ]}^{′} \qquad ( 3 )$$

where 0^{3×1} is a 3×1 column vector of zeros. To focus on the deformation and not consider rigid motions of the whole loop, we can assume that α(0)=β(0)=β(1)=0. For a planar loop, equation ((3)) simplifies to the following.

$${0}^{2 \times 1} = {\sum }_{i = 0}^{n - 1} {l ( i ) [ cos α ( i ) sin α ( i ) ]}^{′} \qquad ( 4 )$$

In this case, to eliminate the rigid motion effect, we can assume that α(0)=0. In both cases, DSpace is described by a system of trigonometric, highly non-linear equations, ((3)) or ((4)). Such systems cannot be solved efficiently with our current knowledge of nonlinear equations, except in very special circumstances. As with the algebraic description, the potential complication of DSpace, from this viewpoint, grows exponentially with the number of links.

As an example of the complexity of these problem formulations, consider a loop with 1000 joints. If the loop is in space, we need to solve a set of three scalar equations in 1997 variables as in ((3)); if the loop is in the plane, we need to solve a set of two scalar equations in 999 variables as in ((4)). All equations are non-linear and generally cannot be solved efficiently using the prior art.

Deformation Spaces of Loops.

Prior work using conventional parameters has led to some important results for loops. (References: Lenhart and Whitesides, Reconfiguring closed polygon chains in Euclidean d-space, Discrete and Computational Geometry, 1995; Kapovich and Millson, On the moduli spaces of polygons in the euclidean plane. J. Diff. Geom., 1995; Trinkle and Milgram, Complete path planning for closed kinematic chains with spherical joints, Int. J. Robot. Res., 2002; Milgram and Trinkle, The geometry of configuration spaces for closed chains in two and three dimensions, Homology Homotopy and Applications, 2002.) For example, the number of connected components and some other topological properties of deformation spaces of certain kinds of loops has been solved from the perspective of polygons and closed chains. Milgram and Trinkle used joint angle parameters to find the complete structure of DSpace for a loop satisfying a technical condition called “having 3 long links”. These techniques have produced two complete path planners for planar loops, ignoring all other constraints such as collisions and joint limits. The line tracking planner of Lenhart and Whitesides generates a path for an n-link planar loop in time O(n): it uses simple line tracking motions to move two given query deformations to their “standard triangle form”, in two opposite orientations if needed, and then to move both triangle deformations to an appropriate singular deformation that allows the change of the triangle orientations; for some start and goal deformations, only one standard triangle form needs to be passed through. The accordion planner of Trinkle and Milgram generates a smooth path between given deformation pairs of a planar loop, and empirically exhibits cubic running time. Milgram and Trinkle also use their demonstrated structure for DSpace, in the special case of “3 long links”, to generate paths by linear interpolation of angle parameters. For all these planners, the expression of DSpace in terms of some conventional coordinates makes it difficult if not infeasible to efficiently include other constraints like collision avoidance or joint angle limits.

Distance Parameters and Trilaterable Manipulators

As described earlier, the position of a point can described and determined by its distances to three points of known positions. This computation is called trilateration. For a set of points P(1), . . . , P(n), if all their pairwise distances are known, we can form a distance matrix as follows.

$$Dist = [ \begin{matrix}0 & D ( 1 , 2 ) & … & D ( 1 , n ) \\ D ( 2 , 1 ) & 0 & … & D ( 2 , n ) \\ … & … & … & … \\ D ( n , 1 ) & D ( n , 2 ) & … & 0\end{matrix} ] ,$$

Here D(i, j)=∥P(i)−P(j)∥². Given a valid distance matrix, we can find points satisfying the specified distance matrix. One way to do so is to compute the Gram matrix G associated with Dist. The entries of G are G_{i,j}=1/2(D²(i, n)+D²(j, n)−D²(i, j)). The Cholesky factorization of G into G=XX′ gives us a matrix X, whose rows are coordinates for P(1), . . . , P(n), up to rigid motions and mirror transformations.

For some problems of multipoint systems, their system properties, problem specification, and constraints can be encoded into an incomplete distance matrix. If the distance matrix can be completed, the system configurations can be computed. One way to fill a distance matrix is to repeatedly use the following computation. Assume that the distances among three points (P(1), P(2), P(3)) are specified, as are the distances from P(4) and P(5) to these three points. Then the squared distance between P(4) and P(5) can be computed with the following formula.

$$D ( 4 , 5 ) = \frac{{a}^{2} C M D ( 1 , 2 ) + {b}^{2} C M D ( 1 , 3 ) + 2 ab C M B D ( 1 , 2 ; 1 , 3 )}{C M {D}^{2} ( 1 , 2 , 3 )} + \frac{c}{C M D ( 1 , 2 , 3 )}$$

$$a = C M B D ( 1 , 2 , 3 ; 1 , 3 , 5 ) - C M B D ( 1 , 2 , 3 ; 1 , 3 , 4 )$$

$$b = C M B D ( 1 , 2 , 3 ; 1 , 2 , 4 ) - C M B D ( 1 , 2 , 3 ; 1 , 2 , 5 )$$

$$c = C M B D ( 1 , 2 , 3 , 4 ) - C M B D ( 1 , 2 , 3 , 5 ) \pm \sqrt{C M D ( 1 , 2 , 3 , 4 ) C M D ( 1 , 2 , 3 , 5 )}$$

$$Here$$

$$C M B D ( {i}_{1} , … , {i}_{n} ; {j}_{1} , … , {j}_{n} ) = 2 {( \frac{- 1}{2} )}^{n} \vert \begin{matrix}0 & 1 & … & 1 \\ 1 & D ( {i}_{1} , {j}_{1} ) & … & D ( {i}_{1} , {j}_{n} ) \\ 1 & … & … & … \\ 1 & D ( {i}_{n} , {j}_{1} ) & … & D ( {i}_{n} , {j}_{n} )\end{matrix} \vert$$

with D(i, j)=∥P(i)−P(j)∥, is called the Cayley-Menger Bi-Determinant (CMBD) of the point sequences (P(i₁), . . . , P(iₙ)) and (P(j₁), . . . , P(jₙ)). For many problems, these two point sequences are the same. So it is common to use the simplified notation CMD(i₁, . . . , iₙ) for CMBD(i₁, . . . , iₙ; i₁, . . . , iₙ); this is generally called the Cayley-Menger Determinant (CMD) of the point sequence. (There are various versions of the Cayley-Menger Determinant definition, with minor differences such as in the coefficient for the matrix determinant, and different arrangements of the rows and columns of the matrix.)

The Cayley-Menger determinant based on the bi-determinant definition above is ((n−1)!)² times the square of the volume of the simplex in (n−1)-dimensional Euclidean space spanned by the points (P(i₁), . . . , P(iₙ)). With this interpretation, it is easy to see that the formula for D(4, 5) is not well defined only when CMD(1, 2, 3)=0, i.e. the three points are collinear and don't form a non-degenerate triangle. When the formula is well defined, and when at least of CMD(1,2,3,4) and CMD(1,2,3,5) is zero, i.e. at least one of P(4) and P(5) is on the plane defined by the three points P(1), P(2), P(3), the distance between P(4) and P(5) has one unique value. Otherwise, there are two values.

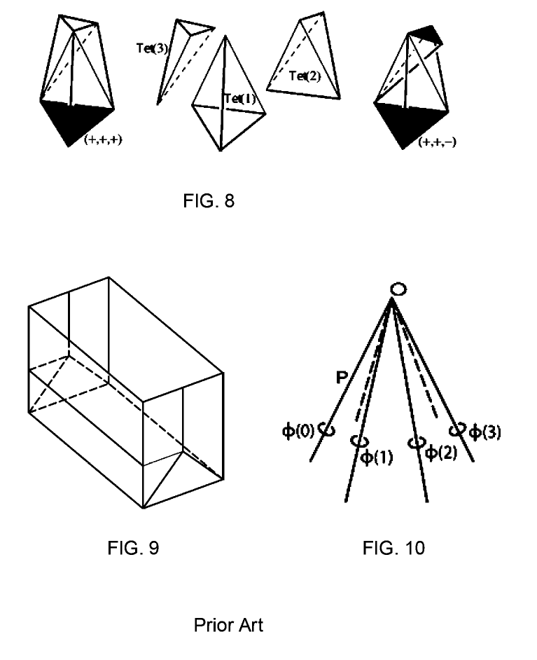

In recent work (On the trilaterable six-degree-of-freedom parallel and serial manipulators, Proc. IEEE Int. Conf. Robot. Autom. (ICRA), 2005), Porta, Ros, and Thomas call a distance matrix, and its corresponding manipulator system, trilaterable if the unknown distance entries can be determined by using formula ((5)) repeatedly. They have developed an algorithm to enumeratively identify all trilaterable six-degree-of-freedom parallel and serial manipulators. Intuitively, each movable point in a trilaterable system has a associated tetrahedron reflecting its distances to three known points. FIG. 8 shows two deformations and three tetrahedra of a trilaterable parallel platform; the two deformations differ only in the orientation of one tetrahedron. The manipulator systems addressed by Porta, Ros, and Thomas are already given in trilaterable form. That is, the given kinematic structure already includes explicitly all distance parameters needed for determining system deformations, such as lengths of the legs between the base and platform of a parallel manipulator. This is a limitation on the applicability of this part of the prior art.

Foldable Objects

In our daily life, we encounter a lot of foldable objects such as brown paper bags. Foldable objects are generally made of inexpensive materials such as paper, cardboard, cloth and sheet metal. When folded, they are easier to store and ship in mass. Usage of them generally involves reconfiguring them into different shapes, for instance, unfolding into some (semi-)rigid 3D structure. To work with these objects and design foldable objects with some desired properties, it is important to find parameters for the configurations of these foldable objects, determine constraints on the parameters, and generate paths between different configurations. Normal use of foldable objects involves folding and unfolding, but not cutting up. So there are many complex constraints involved in maintaining system structures and allowing system deformations.

Foldable objects like cardboard boxes have crease patterns associated with them. Each crease line allows relative rotations between two facets sharing the line; it can be viewed as a revolute joint (hinge). Assuming that the facets are rigid, the relative configuration between two adjacent facets can be parametrized by an angle, for their relative rotation about the shared crease line.

The intersections of the crease lines are the vertices of the crease pattern. Now assume that one vertex O has n crease lines incident on it. Then n facets, each bounded by two adjacent lines, surround the vertex. Assuming that no tearing is allowed, these n facets have to maintain a closed chain structure, which imposes closure constraints on the angular parameters. Intuitively, this constraint can be understood as follows: pick any point on any one crease line, and subject that point to a sequence of rotations about each of the crease lines; the resulting position of the point should be the same as its original position. This constraint can be mathematically written as follows. (Reference: Balkcom and Mason, Introducing robotic origami folding, Proc. IEEE Int. Conf. Robot. Autom. (ICRA), 2004.)
R(υ₀,θ₀) . . . R(υₙ₋₁,θₙ₋₁)P=P (5)
Here P denotes a point on a crease line, vi denotes the directional vector for crease line i, and θ(i) denotes the rotation angle about crease line i. This equation imposes 3 non-linear constraints on n angular parameters. So in general, a system of n facets incident on a vertex has n−3 independent parameters and its deformation space is n−3 dimensional. The angular formulation above amounts to studying the deformation space in the ambient angle space, with deformation space as a variety implicitly defined by the constraint (5). As in the case of a loop, the use here of traditional coordinates makes the structure of DSpace technically difficult to understand and hard to compute with, because of high degrees of non-linearity.

### BACKGROUND OF THE INVENTION

### Objects and Advantages

Geometrical or topological analysis of the structure of CSpace is performed using parameters for CSpace. Depending on the choice of parameters, the structure will be more or less transparent, and more or less amenable to efficient calculations. An important aspect of our invention is our new parameter set. Our new parameters can make many CSpace calculations much more efficient than possible with the prior art.

Our innovations include the following. (1) We represent the mathematical constraints on multi-point systems entirely or largely in terms of distance measures (rather than angular measures) together with orientation data for simplices. (2) The totality of the configurations of the multi-point systems so represented is expressed in terms of convex sets, and subsets of convex sets themselves described by algebraic (rather than trigonometric) expressions. (3) Our representation in terms of convex sets and their subsets is more economical (in terms of computational resources) than other representations that involve more trigonometric expressions. (4) The mathematical transformations within our representation are expressed and calculated much more economically (again, in terms of computational resources) than mathematical transformations within representations based on older methods. (5) The translation back to a multi-object system, from a multi-point system represented in our terms, is again more economical than in previous methods.

Illustration of Advantages: the Case of Loops

We illustrate these innovations and their advantages with the case of planar and spatial loops. As we will show in the Detailed Descriptions, our invented geometrical parameters and loop closure formulation allow us to solve fine topological and geometrical properties of loop deformation spaces. In fact, in our parameters DSpace for a loop is explicitly assembled out a collection of identical convex pieces.

Our invention also leads to very efficient methods for generating and connecting loop deformations. Our method can compute, in 19 milliseconds on a desktop computer, valid values for our loop parameters that can be used to generate 2⁹⁹⁸ (more than a googol) of related but geometrically different deformations for a planar loop with 1000 links. The same set of values can be paired with a 997-dimensional torus, (S¹)⁹⁹⁷, to produce a family of related but different deformations for a spatial loop with 1000 links.

Further, our invention leads to very efficient methods for path planning. Suppose given a loop with a start deformation and a goal deformation. If the parameter values of the deformations are not provided, we calculate them very quickly. Then, if the loop is spatial, a single linear interpolation in our parameters gives the required path. If the loop is planar the process is more involved but still very efficient. Suppose the planar loop has n links (and, as always, full revolute joints). Preprocessing of order Θ(n) (fast and cheap) generates useful special system deformations. (These include the “standard triangle form” mentioned in the line, but also many others.) Thereafter, it takes constant time Θ(1) to find a sequence of critical intermediate configurations, if needed, for any pair of planar loop deformations (or determine that no path exists). We can form a milestone path from the start to the goal, with a sequence of critical intermediate configurations between them. If a detailed path is needed, we can use linear interpolation between two adjacent milestone path nodes, generating a piece-wise linear path between start and goal. In essence, our invention makes path planning for a loop with spherical type joints no more difficult than path planning for an open chain.

Further Advantage

A further object and advantage of our invention is that it extends considerably the application, to multi-object systems having DSpaces of high dimensionality, complicated topology, or both, several strategies for analysis, control, etc. already present in the prior art.

One important strategy in dealing with hard problems and complex systems is “divide-and-conquer”. The general idea is, first, to divide a specified original problem into multiple sub-problems, each simpler than the original one. Next, the sub-problems are solved. Finally, the solutions of the sub-problems are processed to get a solution to the original problem. This strategy distributes the complexity of the original problem gets distributed into the sub-problems and the interactions among the sub-problems. In favorable cases, each component is more tractable than the original problem.

A system can be divided in many ways. One general approach is to partition the system constraints into subsets, solve each subset of the constraints, and finally merge the results. Another approach is to divide a system into multiple subsystems, then deal with individual subsystems and interactions among subsystems. Different approaches of divide-and-conquer, such as the two just mentioned, can also be used together.

From the divide-and-conquer point of view, any method that makes progress on some difficult constraints is valuable for all systems that involve those constraints. Similarly, any method that makes progress on some type of system is valuable not just for those systems standing alone but also for other systems that have those systems as subsystems. Thus, for instance, systems which are not loops but have loop subsystems can be more efficiently analyzed and controlled using our invention.

### SUMMARY

In accordance with the present invention a method for efficient operations upon configurations of a multi-body system comprises specification of a construction tree of the system from simplices, specification of problem parameters, and computations in terms of those parameters.

### DRAWINGS

### Figures

FIG. 1 shows examples of multi-point systems and multi-point systems under distance constraints.

FIG. 2 depicts multiple configurations and grasping feasibility cases of a human hand.

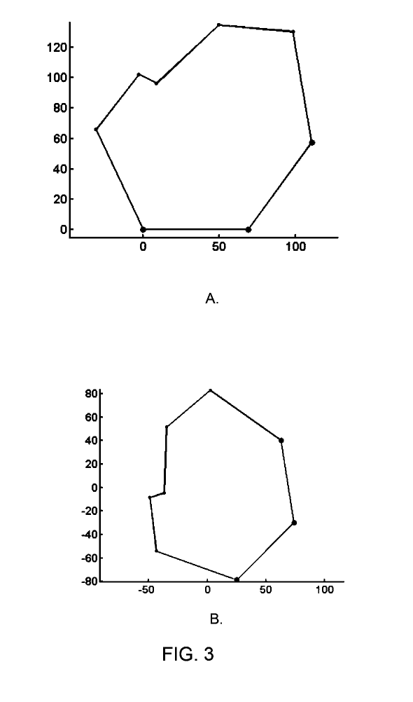

FIG. 3 shows a same deformation of a planar loop at 2 different configurations.

FIG. 4 shows multiple conventional parameters for a point in space.

FIG. 5 shows a multi-fingered robotic hands grasping a ball (Courtesy of Z. Li, HKUST).

FIG. 6 shows a protein drawn in two different styles, including one as a linkage.

FIG. 7 shows a path of a loop generated by our invented method.

FIG. 8 shows a trilaterable parallel manipulator, including its three tetrahedra and two system configurations differing only by the orientation of one tetrahedron.

FIG. 9 shows the crease pattern of a paper shopping bag.

FIG. 10 shows conventional angular parameters for facets around a vertex in some folding crease pattern.

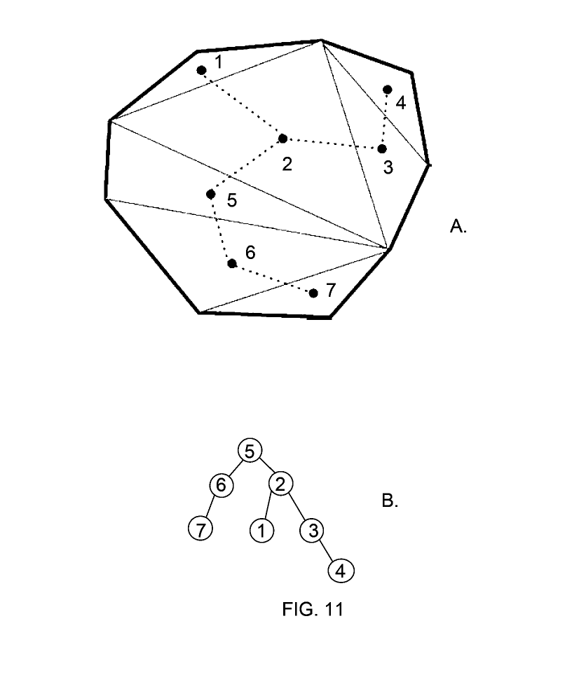

FIG. 11 shows one construction tree of a 9-bar loop from triangles.

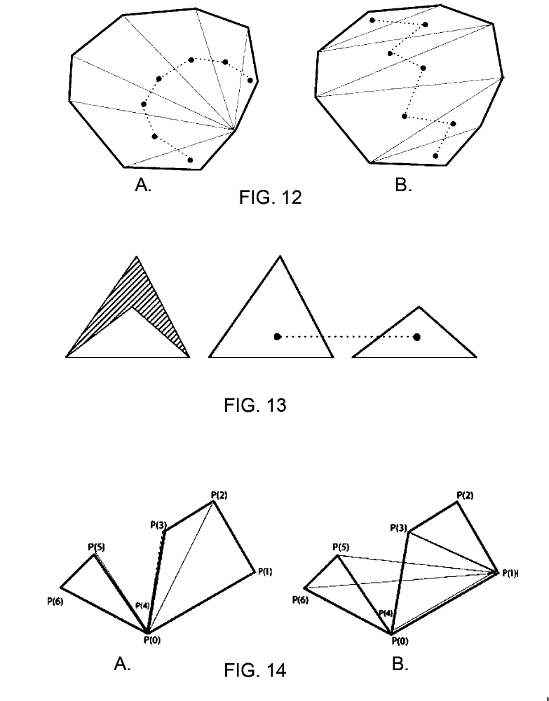

FIG. 12 shows another two construction tree of the 9-bar loop used in FIG. 11 from triangles. The triangles in FIGS. 11 and 12 happen to triangulate the polygonal area bounded by the 9-bar loop at the depicted configuration.

FIG. 13 shows one construction tree of a 4-bar loop from two triangles, where the two triangles don't triangulate the hatched polygonal area bounded by the 4-bar loop at the depicted configuration.

FIG. 14 shows one loop deformation and its two construction tree of triangles, where the deformation is super singular for one construction tree while non-singular for the other tree.

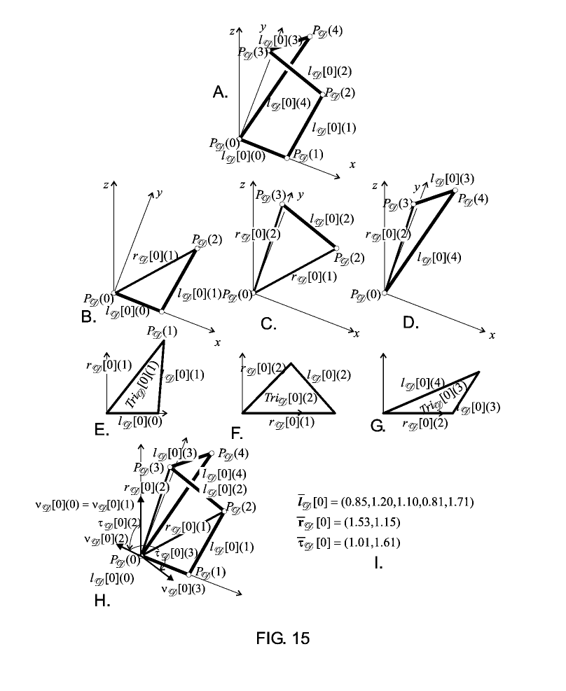

FIG. 15 shows our new triangle-based deformation parameters for a spatial loop and some examples.

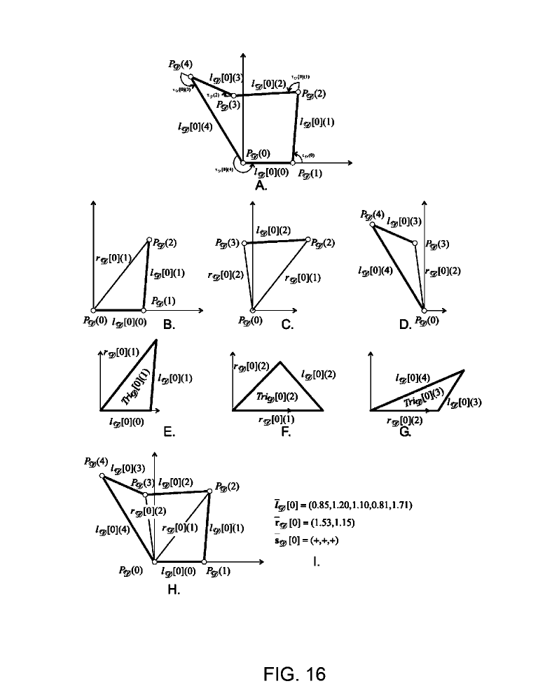

FIG. 16 shows our new triangle-based deformation parameters for a planar loop and some examples.

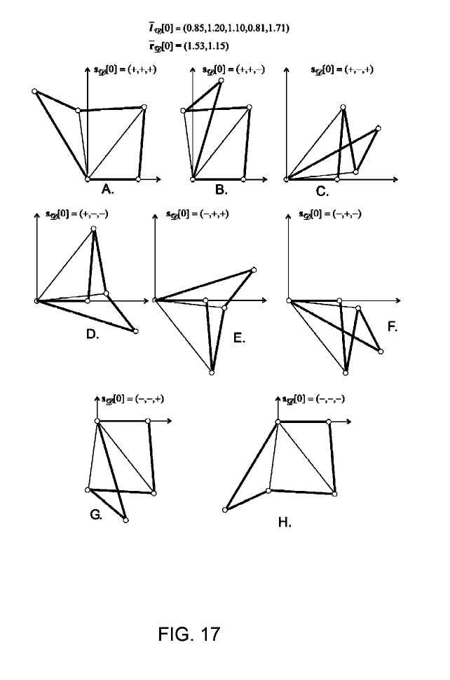

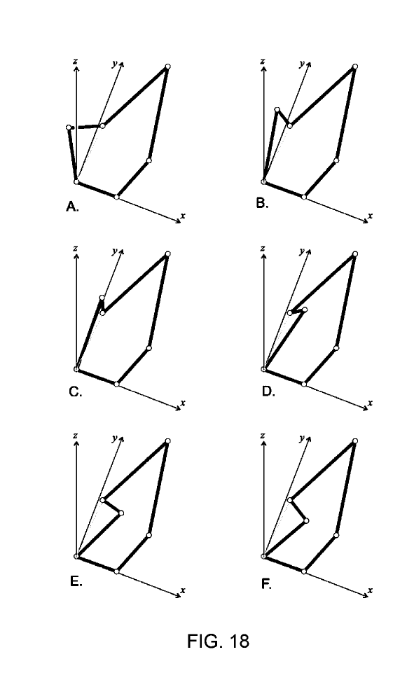

FIG. 17 shows deformations that illustrate the point that diagonal lengths and triangle orientation signs for a planar loop are uncoupled.

FIG. 18 shows deformations that illustrate the point that diagonal lengths and triangle dihedral angles for a spatial loop are uncoupled.

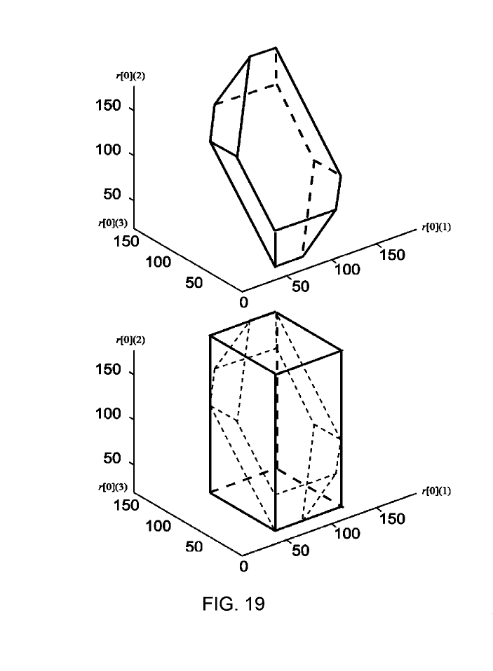

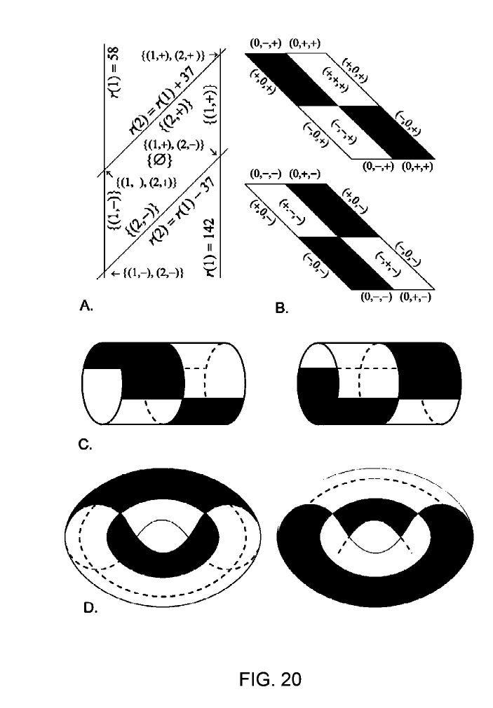

FIG. 19 shows a convex polyhedron corresponding to the set of feasible diagonal lengths, denoted by DStretch in this specification, for a loop with 6 links, and the bounding box of the convex polyhedron.

FIG. 20 shows the stratification of DStretch and the deformation space (DSpace), as well as the DSpace topology, of a planar 5-bar loop with link lengths (100, 42, 37, 95, 89), under the parameterization of our triangle-based parameters.

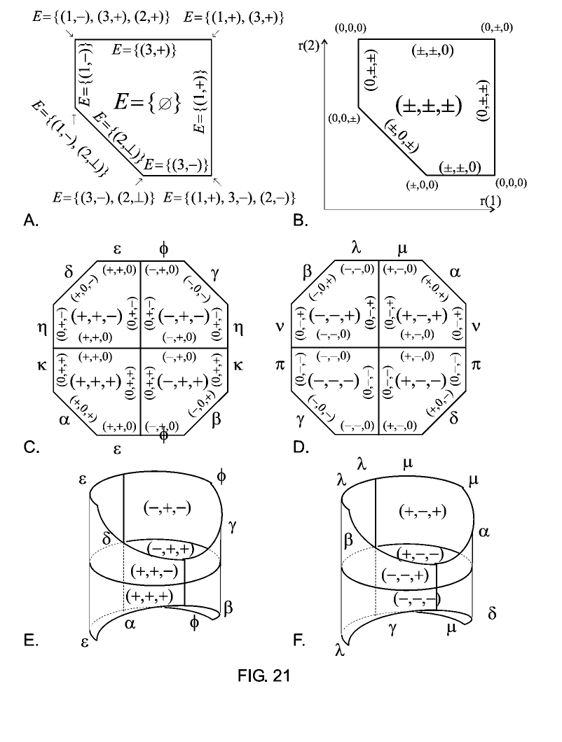

FIG. 21 shows the stratification of DStretch and the deformation space (DSpace) of a planar 5-bar loop with link lengths (2,3,4,2,3), under the parameterization of our triangle-based parameters.

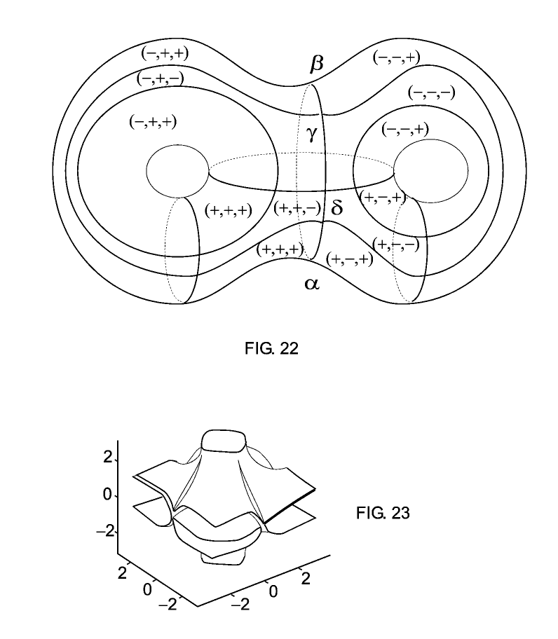

FIG. 22 shows the overall topology of the deformation space DSpace of the planar 5R loop with link lengths (2,3,4,2,3), in the same triangle-based parameters used for FIG. 21.

FIG. 23 shows the deformation space of the same planar 5R loop with link lengths (2,3,4,2,3), under the parameterization of conventional angular parameters. Note that, DSpace in our triangle-based parameters, consisting of 8 copies of a convex pentagon with proper boundary identification as shown in FIG. 21C. and D., has much simpler and nice structures than the one shown in this figure which is parametrized by some angle parameters.

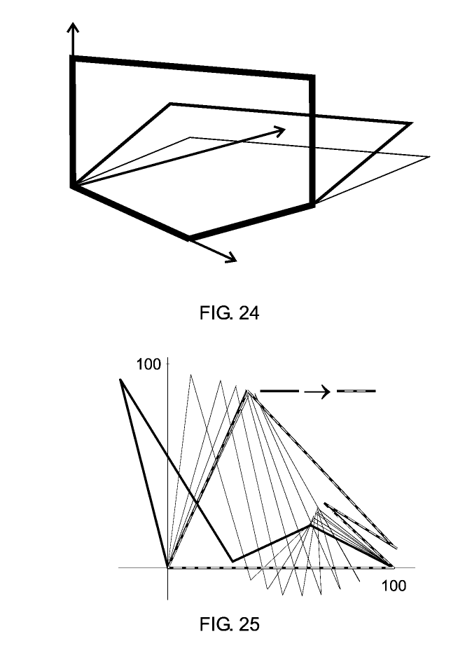

FIG. 24 shows a linear path between two deformations of a spatial loop.

FIG. 25 shows a linear path between two deformations of a planar loop.

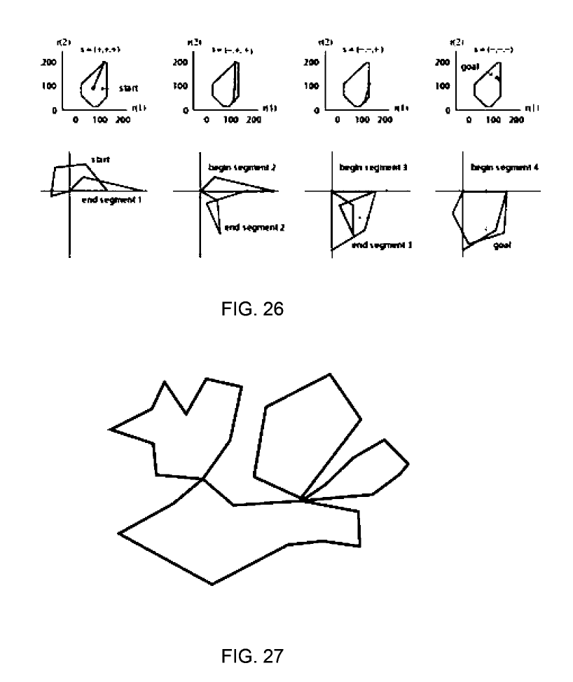

FIG. 26 shows a milestone path between two deformations of a planar loop.

FIG. 27 shows a singular loop deformation.

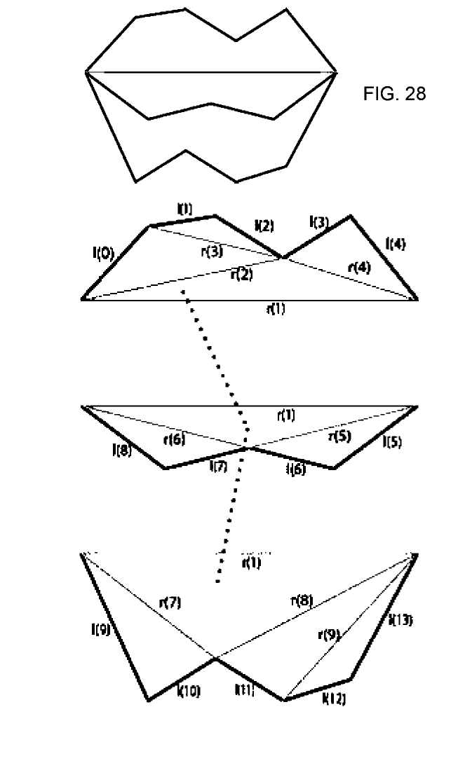

FIG. 28 shows a linkage system with multiple loops sharing edges and its one construction tree from triangles.

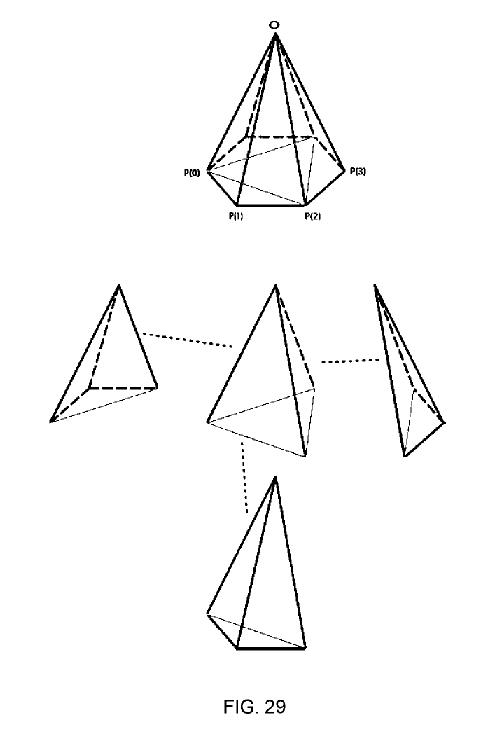

FIG. 29 shows a construction tree of a polyhedron cone (e.g., as a model of multifacets around a vertex in some crease pattern of a foldable object) from tetrahedra.

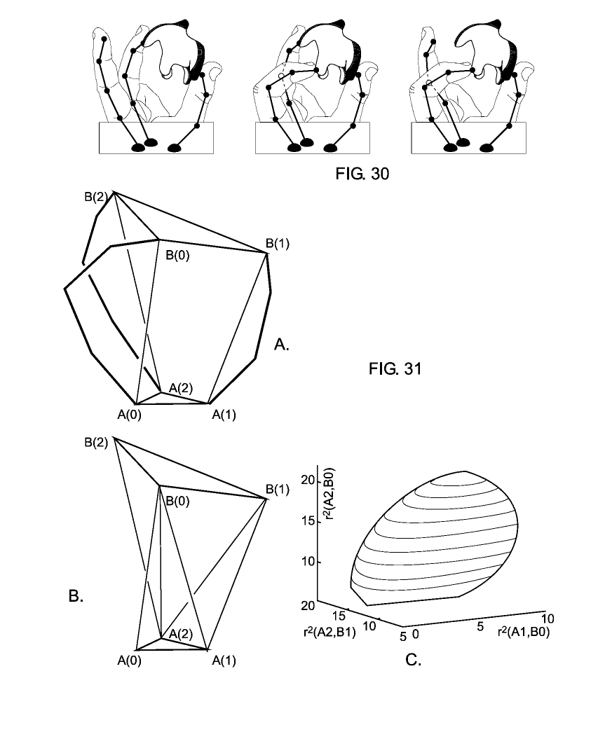

FIG. 30 depicts some hand manipulation.

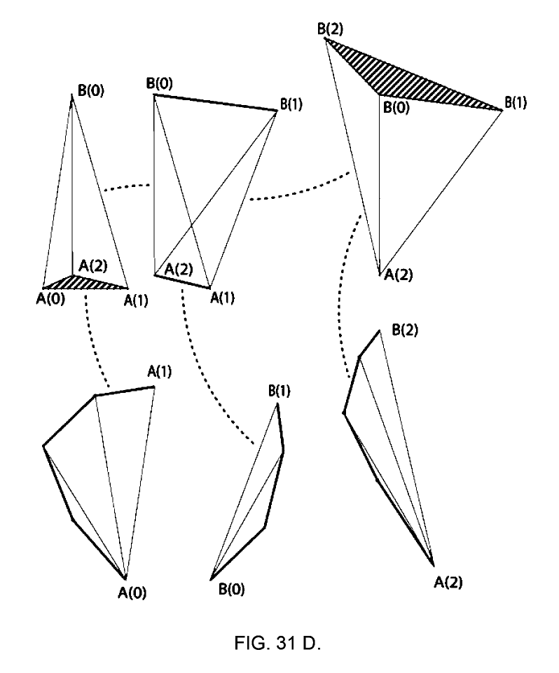

FIG. 31 shows a multi-point model for 3-finger grasps, along with a construction tree of it from simplices comprising both tetrahedra and triangles, as well as a convex set corresponding to a subset set of feasible squared lengths of some diagonals in our simplex-based parameters for the system.

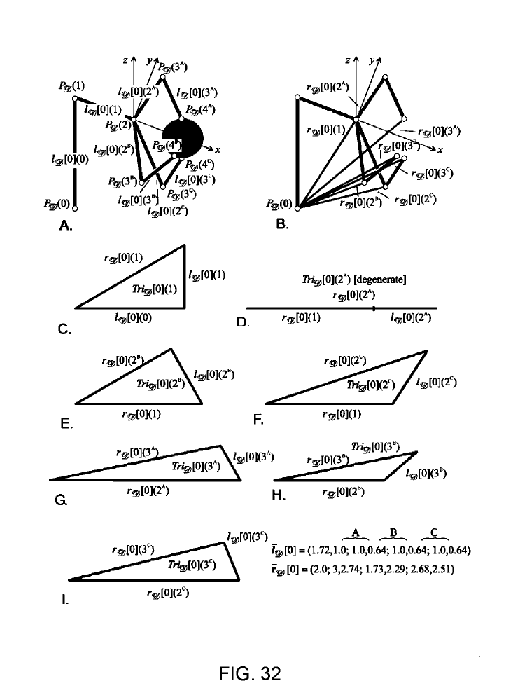

FIG. 32 shows another multi-point model for 3-finger grasps, along with a construction tree of it from triangles.

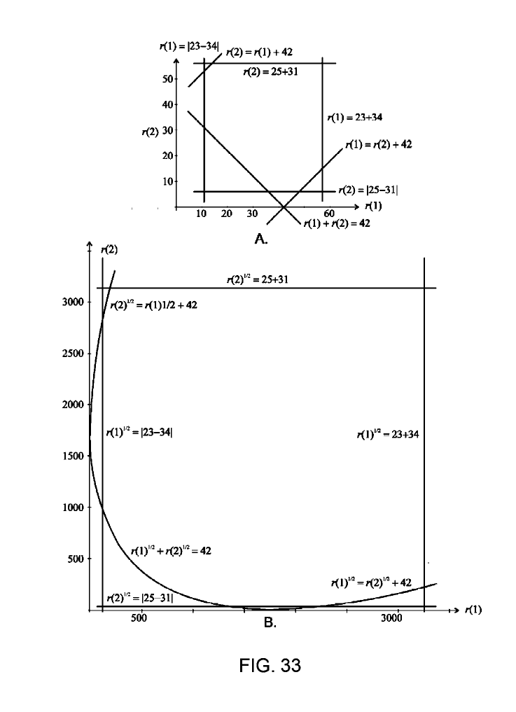

FIG. 33. Two versions of DStretch. A: DStretch for a certain 5-bar planar loop, described in terms of the new parameters r̅. B: DStretch of the same loop, described in terms of the square roots of the new parameters r̅. Note that it is still convex.

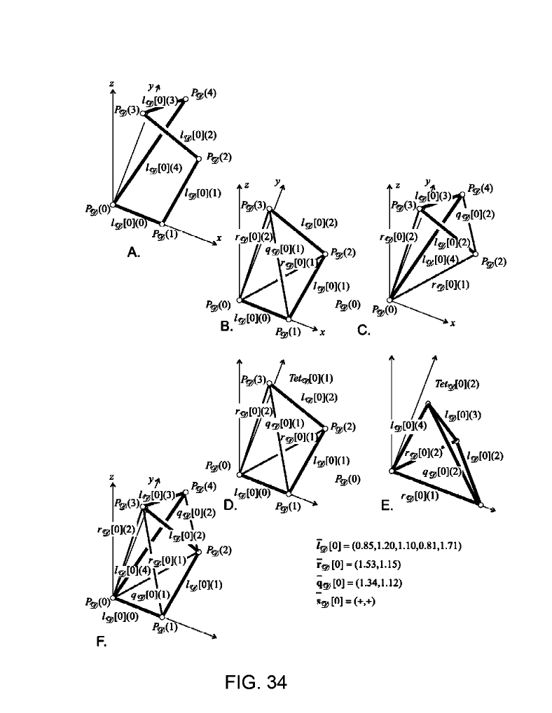

FIG. 34 shows a construction tree of a spatial loop from tetrahedra.

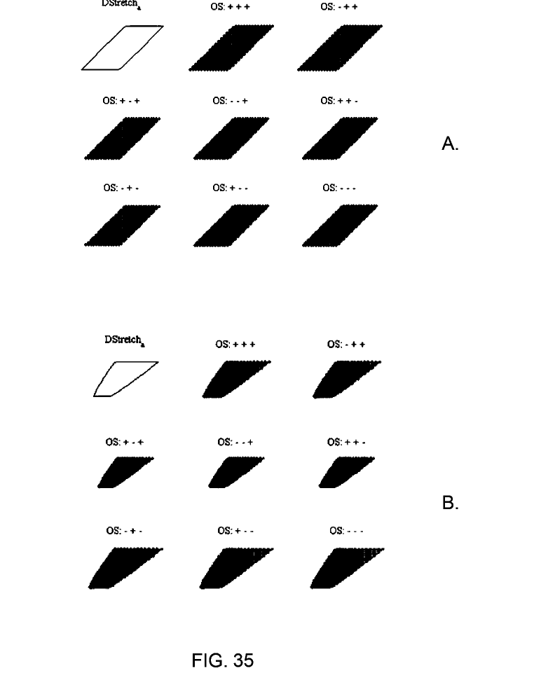

FIG. 35 shows the distribution of deformations involving link interferences (in dark gray) and deformations not involving link interferences (in light gray) of a spatial loop.

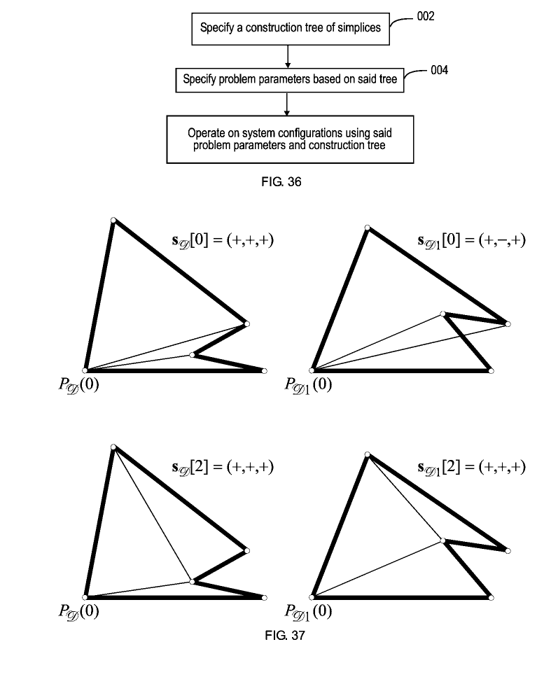

FIG. 36 shows the basic steps of our method for operating on system configurations.

FIG. 37 shows two deformations of a loop, with the two deformations having different orientation sign values for triangles of one construction tree but having same sign values for triangles of another construction tree.

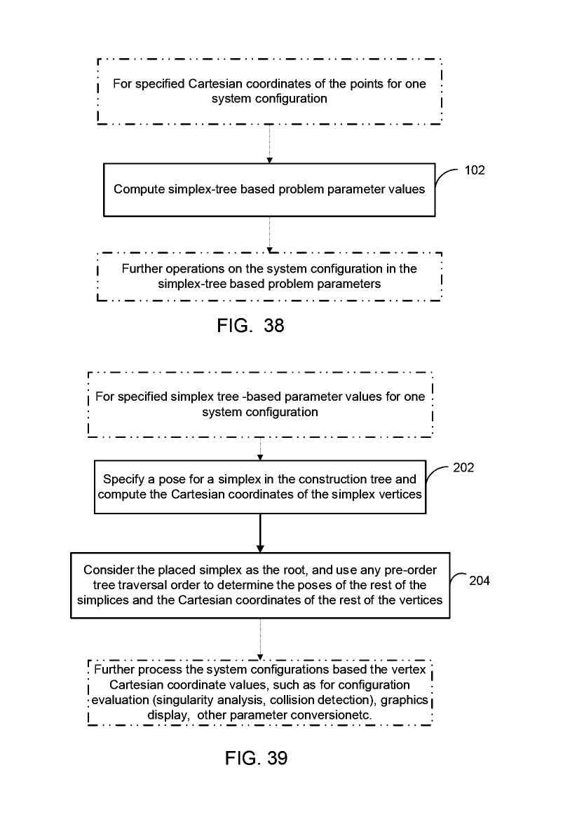

FIG. 38 shows a method for converting system Cartesian coordinates to simplex-based parameters.

FIG. 39 shows a method for converting system simplex-based parameters to Cartesian coordinates.

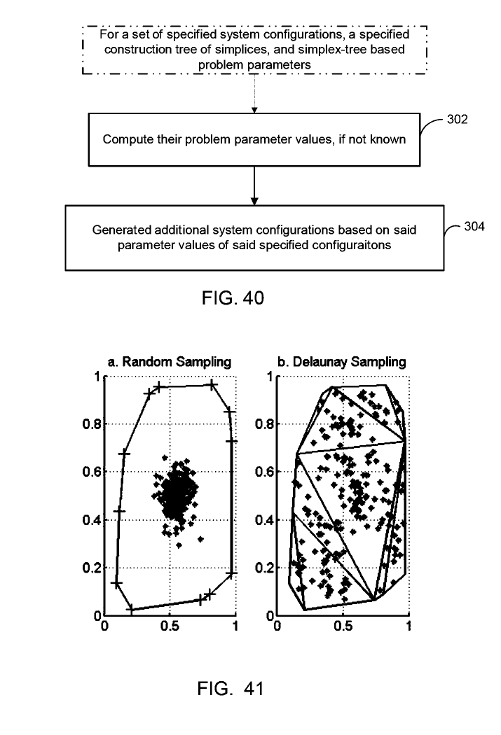

FIG. 40 shows a method for converting system simplex-based parameters to Cartesian coordinates.

FIG. 41 shows a method for generating additional system configurations from a given set of configurations, using the simplex-based parameters.

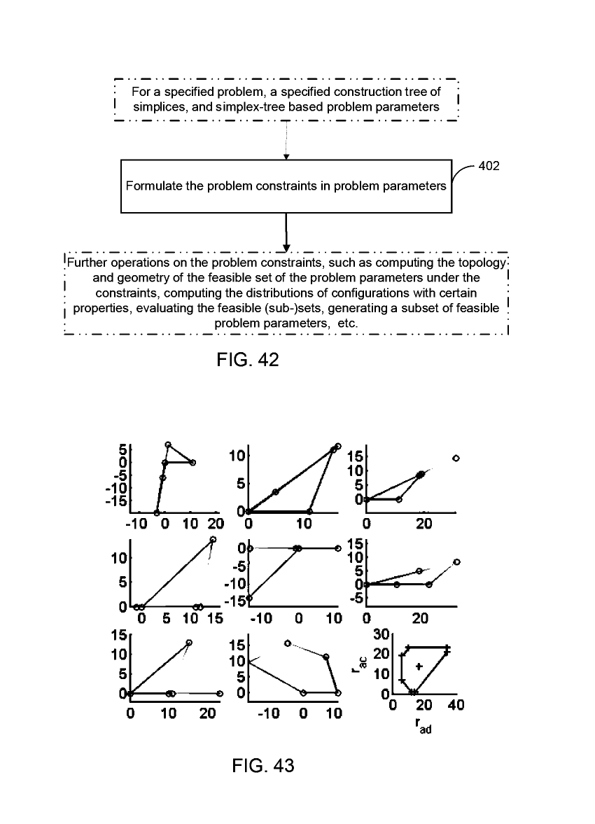

FIG. 42 shows a basic constraint formulation step of a method for operating on system configurations, using the simplex-based parameters.

FIG. 43 illustrates the system deformations of a 5-bar loop with their diagonal lengths being the vertices and centroid of the convex polyhedron set of the feasible diagonal lengths.

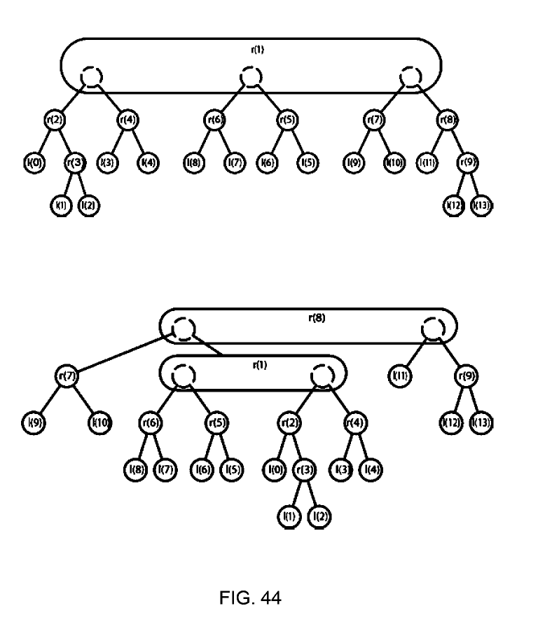

FIG. 44 for two trees for the diagonals and links of the multi-loop system shown in FIG. 28 using the depicted construction tree from triangles.

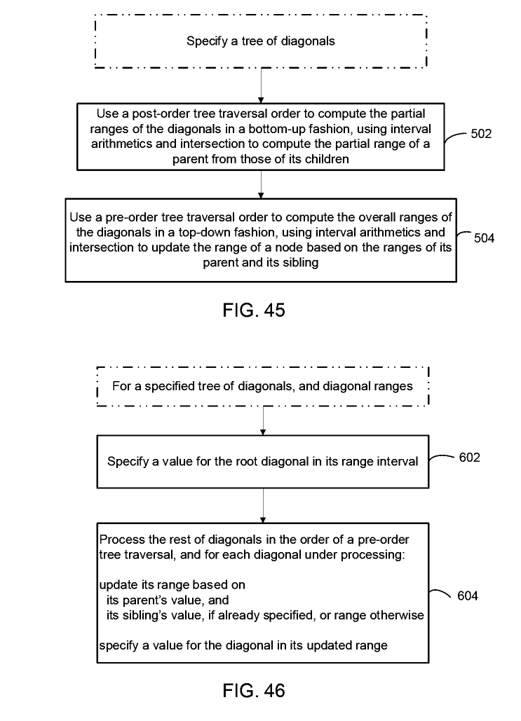

FIG. 45 shows a tree-based method for computing the bounding box, i.e. the minimum and maximum parameter values, of the convex polyhedron set of the feasible diagonal lengths for systems allowing tree constructions out of triangles.

FIG. 46 shows a tree-based method for generating a point in the convex polyhedron set of the feasible diagonal lengths for systems allowing tree constructions out of triangles.

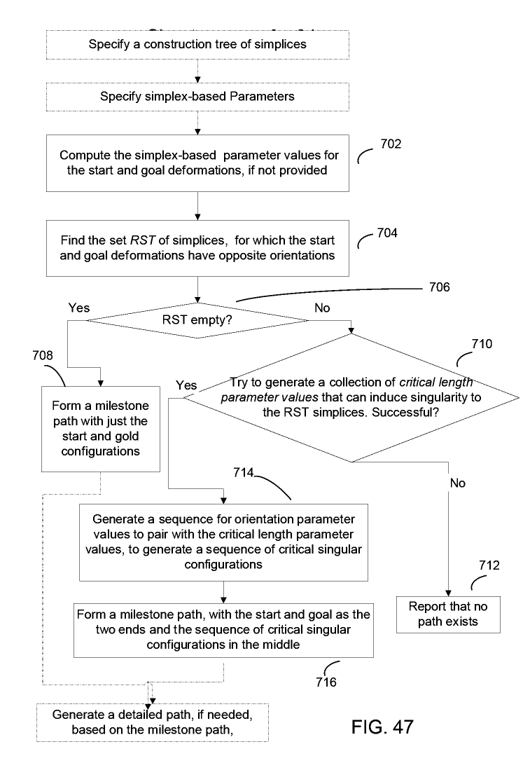

FIG. 47 shows a method for path planning of two system configurations using simplex-based parameters.

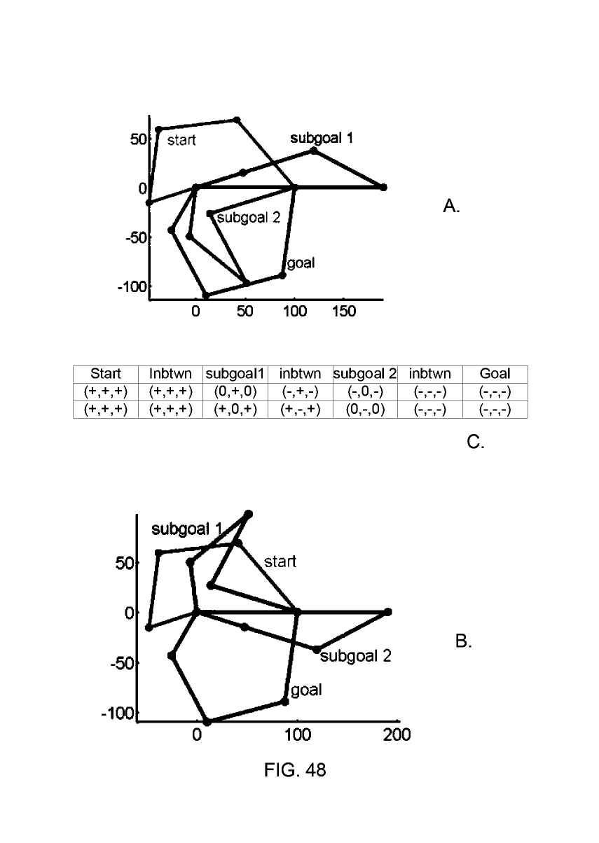

FIG. 48 illustrates two milestone paths for a same pair of deformations of a planar 5-bar loop.

### DETAILED DESCRIPTION

Systems with Loops

In this invention, we will focus on a broad class of multi-body systems having multi-point models with loop constraints among the points. As stated above, even for a general single-loop system there are no efficient method in prior art. So our invention has great practical importance, because many important practical systems involve loops, and there are many important questions about loops with implications for such systems. Here are some representative examples.
Is it feasible to form a loop from a given set of link lengths?
What are appropriate parameters for systems under study and problems to be solved?
How should system constraints be formulated in the appropriate parameters?
How can valid parameter values satisfying system constraints be generated?
What is the topology and geometry of the set of valid parameter values satisfying system constraints? For instance, is it set connected? Is it convex? How may it most transparently be parameterized or represented?
How can a path be found joining two given system configurations?
   Of these, only the first is solved in the prior art: if the length of the longest link in the set is strictly greater than the sum of the rest of the link lengths, then a loop cannot be formed; otherwise, it can.

We now describe how to use our invention to solve the rest of the questions on that list, among others, for multi-body systems having multi-point models with loop constraints among the points and allowing tree constructions from simplices. For such systems our simplex-based parameters prove to be superior to linkage angular parameters and Cartesian parameters, which have been problematic as explained earlier.

Simplices

One aspect of our invention is to use simplex-based parameters for operations upon the configurations of multi-body systems having multi-point models with loop constraints among the points and allowing tree constructions from simplices.

Examples of simplices include line segments (1-simplices), triangles (2-simplices), and tetrahedra (3-simplices). More generally, the convex hull S of n+1 points in m-dimensional Euclidean space Eₘ, with m≧n, is an n-simplex if and only if S does not lie in any proper Euclidean (affine) subspace of Eₘ.

An important property of any simplex S is its rigidity. When the inter-point distances of its vertices—i.e. its edge lengths are fixed, the shape of S is fixed. In the language of deformations, DSpace(S) comprises either exactly 1 or exactly 2 points. (The case of 2 deformations happens only for an asymmetric n-simplex in Eₙ, such as a scalene triangle in the plane E₂; so, for instance, DSpace of a scalene triangle in 3-space E₃ comprises a single point.) When inter-point distances of S are allowed to change, they still need to satisfy constraints. The simplest of these are the “triangle inequality” constraints on the edge lengths of a triangle. There are known explicit algebraic formulations of the constraints on n-simplex inter-point distances, for all n.

Linkage Systems and Construction Trees

As described earlier, a multi-object or multi-point system with distance constraints can be modeled with a linkage system. In this linkage model, there is a link between each pair of points that is subject to a distance constraint in the system being modeled. The constraints on the system being modeled become constraints (equalities and inequalities) on the model link lengths. If the distance between two objects or two points is constrained to be fixed in the system being modeled, then the corresponding model link length is fixed. If the distance between two objects or two points is constrained to vary between unequal minimum and maximum values, then the length of the corresponding model link is constrained to lie in that interval.

This method allows us to use linkage concepts, terms, and notations in the following discussion of multi-object and multi-point systems as addressed in our invention.

The first linkage concept we need to introduce is “construction tree”. (We use the word “tree” to refer to a data structure in the way that is standard in mathematics and computer science.) A tree of simplices is a construction tree of a given linkage system if the simplices satisfy the following three conditions.
(1) each link in the linkage system is an edge of at least one simplex in the tree,
(2) the set of points of the multi-point linkage system is exactly the same as the set of all vertices of all simplices in the tree, and
(3) the deformations of the linkage system can be constructed from the shapes of the simplices and relative configurations of simplices adjacent in the tree.

Taking the 9-bar loop in FIG. 11 as an example, the triangle trees drawn in the figure form a construction tree of this loop. Conditions (1) and (2) are easy to check. To check (3) we use an intuitive description of a loop deformation construction process. First, note that determining the coordinates of a point, under certain constraints, can be viewed as placing the point in space at some proper position satisfying the constraints. Similarly, placing down a triangle in space intuitively corresponds to determining the coordinates of its three vertices. From this viewpoint, we can check (3) for the triangles shown in FIG. 11 as follows. When the shapes and relative configurations of the triangles are specified, to construct the corresponding deformation we first place one triangle of the tree say triangle 5 in FIG. 11 arbitrarily in space. Next we place its neighbors in the tree, triangles 2 and 6. Since two neighbors (adjacent triangles) in the construction tree share a common edge, the shape and relative orientation of each neighbor of triangle 5 fixes its position. Next, their neighbors of (that have not been placed yet), namely triangles 7, 1 and 3, are placed; and so on, until all triangles are properly placed. (Notice that triangles 6 and 2 can be placed simultaneously, or either before the other; they don't interact.)

Rooted Construction Trees; Rigid Transformations

Our definition of construction trees does not require them to be rooted or unrooted. But some operations on construction trees can be more conveniently expressed using concepts, notations and methods of rooted trees. Take the triangle placement process just described as an example. Using the rooted tree depicted at the bottom of FIG. 1, the above process can be concisely described as a pre-order traversal operation. That is, each node is visited (i.e., the corresponding triangle is placed), and a parent node is visited before its child(ren). For the implementation of the process, we can use any one of many existing pre-order tree-traversal algorithms to generate a visit order for the simplex nodes, then process them in turn. So in the following description, if we use parent-order relationship and/or tree traversal, we imply a rooted tree version of the construction tree. If the initial construction tree is not given as rooted, it can be easily turned into a rooted tree, or be treated as a rooted tree. So generally we won't draw construction trees as rooted in the following description.

Also note that one unrooted tree can be turned into different rooted trees. Again consider the triangle placement example above. If we decide to first place a different triangle, say triangle 2, we end up working with a different rooted tree (node 2 is its root, not node 5). Different rooted trees may have different properties, such as height and width. Some tree could be favored over others for certain problems. In this description, we assume that a rooted tree is specified, by users or through computation, based on some selection criteria.

Clearly the process of placing down all the triangles and thus all the links of a linkage system described above is generally applicable any linkage systems allowing a tree construction from simplices. For the process of placing down the simplices in the order of a pre-order tree traversal, a particular placement of this root triangle leads to a deformation of the linkage system and one particular configuration of the system having that deformation. If the system needs to achieve some specified configuration, such as having one triangle of three points at one particular pose, this can be down by carefully choosing the pose of the root simplex or by using rigid transformation from one particular configuration (generated by some choice of the configuration of the root simplex) to the required pose.

For example, FIG. 3 shows one deformation of an 8-link loop in two different configurations. Suppose we first, through some choice of root triangle configuration, place the links at the configurations shown in FIG. 3A. If we are now further required to have the center of all the joints (with its coordinates being the average of joint coordinates) at the origin, and to change the orientation of the loop by 45° (as in FIG. 3B), we can use a rigid motion to change the system from the configuration shown in A to that in B. Rigid-motion related computation is well-understood by those having ordinary skills in the arts of multi-body systems such as robotics or computer graphics. So for many problems, difficulty in working with configurations of multi-point systems is really related to system deformations. Constraints like loop closure are independent of rigid motions since a loop remains closed under any rigid motion. So effectively these constraints are defined on system deformations.

Simplex-Based Parameters

Since the shapes and relative configurations of simplices determine system deformations, our deformation parameters comprise parameters needed for determining the shapes and relative configurations of simplices.

The shape of a simplex is determined by its edge lengths. Some edges of simplices are links, of which some have fixed length and others (perhaps) variable length. A simplex edge that is not a link of the linkage system is called a diagonal. The diagonals are drawn in gray lines in FIG. 11 and other similar figures in this application. Our shape parameters comprise the lengths of the diagonals and the lengths of links of variable length.

Two simplices in a construction tree are adjacent if they share some geometrical entities. Two tetrahedra that sharing a face are adjacent. Two triangles that share an edge are adjacent. A triangle and a tetrahedron that share an edge are adjacent. In some applications, two simplices that share just one vertex are adjacent. In any case there is no relative translation between two adjacent simplices: the only “wiggle room” in their relative configurations is their relative orientation. Our orientation parameters describe these relative configurations of adjacent simplices. (They are described in detail below.)

In summary, our simplex-based parameters for deformations comprise
lengths of diagonals and links with non-trivial range intervals (for the shapes of the simplices), and
orientation parameters (for the relative configurations of adjacent simplices).

As will become clear soon in a few representative examples, our simplex-based parameters have many major advantages over conventional parameters. For example, in our parameters standard loop closure constraints reduce to constraints on the shape parameters (length variables) for successfully forming simplices; there are known explicit formulations for such constraints. Further, given a set of shape parameters (length variables) which allows successful formation of the simplices, the relative configurations of adjacent simplices can be changed without breaking any loop in the system. In other words, when only the loop constraints are considered there is no constraint on the orientation parameters. Further, DSpace parameterized by simplex-based parameters has a transparent, combinatorially defined stratified structure; and the strata in this structure have concrete and useful physical interpretations. As a result, CSpace (parameterized by simplex-based parameters for the deformation part together with well-understood) also has a transparent structure. Generation and path planning of configurations of the systems addressed in our invention can be solved very efficiently in these new parameters.

In the following, we will give an extensive description of our novel approach for parameterizing and operating upon deformations of single loop. This system is of course the easiest to describe among all systems having loops, but it is very representative. We will then move on to other example systems to further illustrate our approach and show the broad applicability and practical importance of our invention.

Example: Single Loop Systems

In the following description, we will use the linkage model and terminology to describe our problems and methods. We will use the term loop to refer to a sequence of points forming a single loop, if we don't need to distinguish whether our system the points is in space or in the plane. If we do need to distinguish, we will call them a spatial loop or a planar loop, as the case may be. If we want to convey the information that the system has n points, we will call it an nS loop if the loop is in space, an nR loop if the loop is in the plane, or an n-bar loop if the distinction between space and plane is immaterial. We will also use the words “points”, “joints” and “vertices” interchangeably, referring to the points in the system.

In the description and figures, we sometimes use simplified notations without including all labels as in definitions. For example, we sometimes do not include T in a notation of an entity; but if the definition of the entity involves a tree, a tree is part of the entity and is compressed in the notation to make the notations shorter and the figures clearer.

Consider a loop of n points P(0), . . . , P(n−1). Denote the distance between points Pₖ_{₁} and Pₖ_{₂} by d(k₁, k₂); thus d(k, k+1) is the length of the link between P(k) and P(k+1) and will sometimes also be referred to as the link length l(k). Refer to the vector of all link lengths by l̅.
l̅=[l(0), . . . , l(n−1)] (6)

Assume that n̅ links of the loop have non-trivial length intervals, with unequal minimum and maximum values ll(iₖ) and lu(iₖ), where iₖ ε{0, . . . , n−1} is the index of k^{th} link with a variable length, and k=1, . . . , ñ. Put all these variable link length parameters into a vector.
l v̅=[l(i₁), . . . , l(i _{n̅})] (7)
ll(iₖ)≦l(iₖ)≦lu(iₖ),k=1, . . . , ñ (8)

A non-trivial length interval for a link can be used to model a prismatic joint in the direction of the link. It can also be used to model some properties related to the links, for example the hardware limits, manufacturing tolerances, and some relevant properties on the end points of the links. A link with a fixed length can also be treated as a link with a (trivial) variable length range, with both the lower and upper bounds of the range interval equal to the fixed length. It is fine to further expand the vector of variable link length parameters l v̅ to include these fixed link length parameters, which are constants by nature. That expanded version of l v̅ is equivalent to l̅ defined in equation (6). In this patent application, we will use the strict definition of l v̅ as in equation (7), which can generally achieve the same effect as the expanded version and be more computationally economical. However, it is straightforward to implement our inventions with l v̅ replaced by l̅. For a loop with all links have fixed lengths, l v̅ is a null vector.

Construction Trees of Triangles for a Single Loop

As shown in FIG. 11, a loop allows a tree construction from triangles. There are many ways to define and generate construction trees of triangles for a loop. Trees of anchored triangles are among the easiest types of construction trees for loops to describe and generate. Given a loop with n joints, choose an arbitrary joint as the anchor a, then and draw the diagonals from anchor a to all other (n−3) non-adjacent joints. These (n−3) diagonals and the n loop links form (n−2) anchored triangles that all share the anchor vertex (as in FIG. 12A). When going through the anchored triangles from one end to the other, i.e. from the anchored triangle involving one of anchor a's two neighbors to the triangle involving the other, the anchored triangles form a linear chain.

Other than anchored triangles, we can also use the techniques developed for triangulation of polygons. For our purpose, we adopt a strict definition of polygonal triangulation, where a triangulation of a polygon P is its partition into non-overlapping triangles whose union is P and vertices are only vertices of P. To generate a triangle construction tree of a loop with n joints, we can use a triangulation of a n-sided polygon at some general configuration, and the resulting triangles, to form a construction tree. For the simplicity of computation, convex polygons are preferred but not necessary. The triangles shown in FIGS. 11 and 12 all happen to triangulate the enneagonal area bounded by the 9-bar at the depicted configurations. However, note that, for some loop configurations, the triangles in its construction tree do not form a triangulation of the polygonal area bounded by the loop at those configurations; consider the two triangles for the depicted configuration of a 4-bar loop shown in FIG. 13.

For a loop with n joints, each of its construction trees of triangles has n−2 triangles and n−3 diagonals. Two adjacent triangles share one unique diagonal; their relative configuration is restricted by their relative orientations. Refer to a construction tree from triangles in use by T. Denote the triangles in the tree by Tri([)T](j),i=1, . . . , n−2, the diagonals and their lengths by diag[T](j) and r̅[T](j), j=1, . . . , n−3. Then put all the diagonal lengths into a vector.
r̅[T]=[r[T](1), . . . , r[T](n−3)]. (9)

Following the earlier description of our general definition of simplex-based parameters, our triangle-based parameters for deformations of a loop comprise

length parameters including r̅[T] and l v̅, and

orientation parameters for relative configurations of adjacent triangles.

Depending on whether the motion of the loop under study is in space or restricted to a plane, we have different orientation parameters.

Next, we still further formalize the notation and define the orientation parameters, first for a spatial loop and then for a planar loop.

Orientation Parameters for A Spatial Loop

Every two adjacent triangles of a construction tree share a common diagonal. For two adjacent triangles, when its common diagonal has a non-zero length, the only possible motions between the two triangles are the rotations about the common diagonal. If both triangles are not degenerate, then relative rotations about the common diagonal will lead to new relative configurations between the triangles, which can be parametrized by an angle parameter between the two intersecting planes defined by the triangles. There are many ways for defining an angle for two intersecting planes. One general approach is to define a normal vector for each triangle and compute some angle related to the two normals. For example, the so-called dihedral angle can be defined as the signed angle for rotating one normal to the other about their cross-product.

Regardless of specific definitions which could use different choices for involved entities such as normal vector directions and angles between vectors, different angular definitions for two intersecting planes are equivalent and can be straightforwardly converted to each other. In the rest of the description, we will use the term “dihedral angles” for the angles between two adjacent triangles, as the token term for all equivalent angular parameters.

For a spatial nS loop and a particular construction tree from triangles T, we define one dihedral angle for each two adjacent triangles and use the n−3 dihedral angles, organized into a vector τ̅[T], as the orientation parameters for relative configurations of adjacent triangles.
τ̅[T]=[τ[T](1), . . . , τ[T](n−3)]′
Singular and Super-Singular Deformations

At a given deformation, Tri([)T](j) is degenerate (i.e., reduces to an anchored line segment) if and only if its vertices are collinear, which can happen in two non-trivial distinct ways: either Tri([)T](j) has all three positive side lengths and thus three distinct but collinear vertices, or Tri([)T](j) has at least one zero-length side, and thus at most two distinct vertices, in which case we call it doubly degenerate. Assuming this side is a diagonal, then the neighbor of this triangle that shares the zero-length diagonal is also doubly-degenerate. We will call a deformation singular with respect to a construction tree from triangles, if at least one triangle is singular; and a deformation super-singular if at least one triangle is doubly degenerate, again with respect to some construction tree from triangles.

Note that singularity of deformations in our triangle construction approach is dependent on the particular tree in used. A same deformation may be singular, even super singular with respect to one construction tree, while it is not singular at all with respect to another tree. FIG. 14 shows one loop deformation and its two construction tree of triangles, where the deformation is super-singular for the construction tree of triangles anchored at P(0), but not singular for other one having the anchor at P(1). A loop deformation that is singular in the traditional sense, such as degenerate Jacobian, but includes no degenerate triangle for a construction tree from triangles in use poses no problems for our new parametrization, so for our purposes it is non-singular. We will discuss the role of different construction trees later.

A singular triangle, unlike a non-degenerate triangle, does not have a well-defined normal. Also if at least one of the two adjacent triangles is singular but their common edge has non-zero length, each singular triangle is a line segment that overlaps with the common edge. For this case, rotating the two adjacent triangles about the common diagonal will not lead to new deformations. We need to properly define and interpret orientation parameters involving singular triangles. We will describe our method on this regard later.

Further Illustration of Our Parameters

In our discussion so far, we have used a descriptive approach for our parameters and have not explicitly related all the diagonals and dihedral angels to the points of the loop, to avoid complicated notations. Our parameters under a tree from anchored triangles are easy to label. So next we will further illustrate our method by explicitly relating these parameters to the loop points using a construction tree of anchored triangles.

For our description involving a tree from anchored triangles, we need to frequently refer to some j^{th} entity (such as joint, link, etc.) counted from joint A, which should have index (i+j) (mod n) to model the cyclic nature of the loop joint and link indices. To simplify the description, we use notation (i; j) for this computation.
(i;j)=(i+j)mod n
We will also refer to the distance between a base joint P(base) and an joint which is offset^{th} joint from the base, and we introduce the following notation.
δ(base, offset)=∥\vec{P(base)P(base; offset)}∥

Denote the index of the anchor joint by a. Instead of using the generic T for a construction tree from triangles, we will just use the anchor index a to refer to a construction tree from anchored triangles, with a as the anchor. For anchor P(a), in general, we call an entity “anchored” if it includes P(a). For j=2, . . . -2, we call the vector P(a)P(a; j) an anchored diagonal of the loop. Note that the vectors P(a)P(a; 1) and P(a)P(a; n−1) are links of the loop. we denote the vector from P(a) to P(a; j+1) by \vec{diag}[a](j) and its length by r[a](j).
\vec{diag}[a](j)=\vec{P(a)P(a;j+1)},j=1, . . . , n−3 (10)
r[a](j)=∥\vec{diag}[a](j)∥=δ[a](j+1) (11)
Put the lengths of the genuine diagonals into one column vector
r̅[a]=[r[a](1), . . . , r[a](n−3)]′ (12)
where ′ indicates vector transpose.

For j=1, . . . , n−2, we denote by Tri([)a](j) the anchored triangle with vertices at joints P(a), P(a; j), and P(a; j+1). For jε{2, . . . , n−3}, Tri([)a] (j) is an internal node of the anchored triangle chain, with one edge being the link l(a; j) and the others being anchored diagonals r[a](j−1), r[a](j). Tri([)a](1) and Tri([)a] (n−2) are the two end nodes of the anchored triangle chain, each having two links and one diagonals as its sides. Denote the normal of Tri([)a](j) by \vec{n}[a](j). Then
\vec{n}[a](j)=\vec{diag}[a](j−1)×\vec{diag}[a](j),j=2, . . . , n−3 (13)
The normal vectors for Tri([)a](1) and Tri([)a](n−2) can be similarly computed by replacing one diagonal in the formula above by an appropriate link.

Now define the dihedral angle τ[a]((j) as the angle needed for rotating n̅[a](j) to n̅[a](j+1) about the axis d i̅a̅g[a](j) (perpendicular to both n̅[a](j) and n̅[a](j+1)).
n̅[a](j+1)=Rot(d i̅a̅g[a](j),τ[a](j)) n̅[a](j),j=1, . . . , n−3 (14)
where n̅[a](j) and n̅[a](j+1) are the unit normals of Tri([)a](j) and Tri([)a](j+1), Rot(d i̅a̅g[a] (j), τ[a] (j)) is the 3×3 matrix representing rotation about the unit diagonal vector d i̅a̅g[a](j) by the angle τ[a](j). Angle τ[a](j) can be computed from formula in linkage textbooks including some robotics textbooks. Putting the n−3 dihedral angles into one column vector, we have
τ̅[a]=[τ[a](1), . . . , τ[a](n−3)]′ (15)

As a summary, for a spatial loop and a tree from anchored triangles having joint P(a) as the anchor, our loop deformation parameters are (l v̅, r̅[a], τ̅[a]).

FIG. 15 illustrates one deformation and parameters of a spatial given 5-bar loop, using a construction tree from anchored triangles. A: The deformation D, with joints labeled PD(0) through PD(4), and link-lengths (indexed from anchor 0) labeled lD[0] through lD[4]. B-D: Theled lD[0] through lD[4]. B-D: The three anchored triangles of the linkage with anchor 0, with the relevant values of the new parameter r̅ labeled. E-G: The same triangles in the abstract. H: The original linkage reconstructed from the three triangles. I: The values of the link-lengths and parameters l̅, r̅(0), and τ̅(0) at the deformation D.

Orientation Parameters for a Planar Loop

For a planar linkage, its dihedral angle τ̅[T](j) may be only 0 or π, depending on whether two adjacent triangles, such as Tri([)a](j) and Tri([)a](j+1) of a tree of anchored triangles, has same or opposite orientations.

Further, the orientation of the root triangle is needed for the parameterization of the deformations of a planar loop, but is not needed for a spatial loop. This is because that 3-dimensional rigid motions can be used to achieve any orientation of the root triangle, but a planar rigid motion cannot move a face-up triangle to a face-down one (staying in the plane). So the orientation parameter for a planar linkage needs to be extended with r̅[T](0) which specifies the orientation of the root triangle. We can assign τ[T](0) to 0 or π if the three triangle vertices stay in a counterclockwise or clockwise order, viewed from some fixed direction.

We have another way for specifying the orientations of all anchored triangles, which is to use an orientation sign for each anchored triangle Tri([)T](j), depending on whether the three vertices, in some pre-specified index order, stay in a counter-clockwise or clockwise order (viewed from some fixed direction). Use an anchored triangle construction as an example. One way to define and compute the orientation sign of Tri([)a](j) is to use the sign of the matrix determinant as follows.
s[a](j)=sign(determinant[\vec{diag}[a](j−1)\vec{diag}[a](j)]),j=2, . . . , n−3 (16)
where each diagonal vector is a 2D vector. Again the formula above can be easily adapted for the two end triangles, Tri([)a](1) and Tri([)a](j−2), with a diagonal vector in the formula above replaced by an appropriate link vector. Under this defin P(a), P(a; j), P(a; j+1) are not collinear and stay in a counter-clockwise (or clockwise) order, when viewed from the positive z direction, and a zero (0) sign when the three vertices are collinear.

This orientation signs and dihedral angles carry equivalent information and can be converted from one to another. They however convey the information in different ways: our orientation signs as described above specify the “absolute” orientation of each triangle and dihedral angles specify the relative orientations between adjacent anchored triangles. We can also define relative orientation signs to indicate whether two adjacent triangles have same or opposite orientation. In this description, we will use the absolute orientation signs as part of the loop deformation parameters, with the understanding that methods described for the orientation sign parameters can be easily adapted to dihedral angle parameters and relative orientation signs. Now putting the orientation signs into one vector, we get
s̅[T]=[s[T](1), . . . , s[T](n−2)]′ (17)

Our deformation parameters for a planar nS loop and its construction tree T of triangles comprise

the changeable link lengths l v̅εR ^{n̅} (Euclidean n-dimensional space),

the diagonal lengths r̅[T]εRⁿ⁻³, and

the triangle orientation signs s̅[T]ε{+, −, 0}ⁿ⁻².

Note that, while we use plus (+) and minus (−) signs for two different orientations of three non-collinear points, these signs can be equivalently replaced by any other pairs of symbols and phrases, such as (clockwise, counter-clockwise), (convex, concave), (up, down), (mountain, valley), (1,−1), (2, 10.1), (side 1, side 2) and (arbitrary, at will). Similarly, the 0 sign can be replaced by any symbol/phrase that is different from those used for plus and minus signs, such as flat, straight, collinear, singular and subjective, etc.

FIG. 16. Notation for parameters of a planar linkage, illustrated with one deformation of a given 5-bar loop. A: The deformation D, with joints labeled PD(0) through PD(4), link-lengths (indexed from anchor 0) labeled lD[0] through lD[4], and exterior angles labeled τ_{D}(k). B-D: The three anchored triangles of the linkage with anchor 0, with the relevant values of the new parameter r̅ labeled. E-G: The same triangles in the abstract. H: The original linkage reconstructed from the three triangles. I: The values of the link-lengths and parameters r̅, s̅ at the deformation D.

Parameter Conversion

In general, there exist different types of parameters for a given system, such as what we described earlier for parameters for points. Different parameters have different traits, and it is useful and important to be able to convert from one set of parameters to another, sometimes via a third set of parameters.

For a loop, conversion between our triangular parameters and conventional parameters, such as the Cartesian coordinates and spherical coordinates, can be efficiently done. Since point Cartesian coordinates can be easily converted with Spherical coordinates and other conventional parameters back and forth, here we will just briefly describe the conversion between triangular parameters and point Cartesian coordinates of a loop.

Given a frame and the Cartesian coordinates of the loop points with respect to the frame, the values of the triangular parameters, namely the changeable link lengths, diagonal lengths, and triangle orientation parameters, can be easily computed using the basic formula for lengths and angles in analytic geometry and vector algebra.

Now we describe the conversion from loop triangular parameters to Cartesian coordinates of points. Here, each of the deformation parameters is given a value, and for now, assumed to be valid. We need to figure out some placement of the points so that the resulting loop deformation has the given values for the deformation parameters.

The general process of converting triangular parameters to point Cartesian coordinate follows the triangle placement procedure described earlier. In short, put a root triangle somewhere in space or the plane, and then place the rest of triangles iteratively in the order of a pre-order tree traversal, based on the shapes and relative configurations of the triangles determined by our length and orientation parameters.

Again, for the purpose of computing one deformation of a system, we can pick any frame and put the root triangle anywhere in the frame. Of course, if there is any requirement or preference for the configuration of the root triangle, we can accommodate it here. For example, it is generally more convenient for computation to use the root triangle to define a coordinate frame, with one vertex as the origin, one triangle edge with a non-zero length defining an axis direction (such as the x axis), and one normal direction of the triangle, when well-defined, as another axis (such as the z axis). Any feasible requirement or preference for the configuration of system having a specified deformation, if not accommodated by the initial choice for the configuration of the root triangle, can be resolved later, using some rigid motion to move the system having the specified deformation to the required configuration.

Next to illustrate the iterative computation involved in placing the rest of the triangles, assume that it is time to place a triangle having vertices P(k₁), P(k₂), P(k₃) and that P(k₁), P(k₂) are also vertices of its parent triangle. So we only need to figure out a position, in other words, the Cartesian coordinate for P(k₃). If we can find the unit direction vector (P(k₁)⁻,P(k₃)), the Cartesian coordinate of P(k₃) can be computed as follows.
P(k₃)=P(k₁)+d(k₁,k₃)(P(k₁)⁻,P(k₃)) (18)

(P(k₁)⁻,P(k₃)) can be computed in many way, and we will give one example method below. Denote the unit vector of the shared edge (P(k₁), P(k₂)) by d i̅a̅g[T](j), and the normal vector of the parent triangle by n̅[T](p). Then the normal of the child triangle, n[T](c), can be computed by rotating the parent normal n̅[T](p) about the common diagonal d i̅a̅g(T,j) by the amount of the dihedral angle value τ[T](j) between these two triangles.
n̅[T](c)=Rot(d i̅a̅g[T](j),τ[T](j)) n̅[T](p) (19)
Next, as an example, assume that the normal of the child triangle is related to the edge vectors of the child triangle by
n̅[T](c)=P(k₁)⁻P(k₂)×P(k₁)⁻P(k₃) (20)
Then we can compute P(k₁)⁻P(k₃) by
P(k₁)⁻P(k₃)=Rot( n̅[T](c),γ(k₁))P(k₁)⁻P(k₂) (21)
where γ(k₁) is the face angle of the triangle at vertex P(k₁) and can be computed, for example, by the Law of Cosines.

$$γ ( {k}_{1} ) = a cos ( \frac{{d}^{2} ( {k}_{1} , {k}_{2} ) + {d}^{2} ( {k}_{1} , {k}_{3} ) - {d}^{2} ( {k}_{2} , {k}_{3} )}{2 d ( {k}_{1} , {k}_{2} ) d ( {k}_{1} , {k}_{3} )} ) \qquad ( 22 )$$

For a planar loop, the computation is simplified since the normal of a non-degenerate triangle n̅[T](j) may only assume one of two opposite directions perpendicular to the plane where the loop is in. With n̅[T](j) easily decidable from the orientation sign parameters of the loop, the direction vector P(k₁)P(k₃) can be efficiently computed in many ways, using teachings in basic plane geometry.

Length Parameters and Orientation Parameters are Uncoupled

From the computation of the joint Cartesian coordinates from our new deformation parameters as described above, we see that the length parameters and the triangle orientation parameters are uncoupled and that the triangle orientations are independent of the loop closure constraints. Given a spatial loop configuration, changing one dihedral angle is equivalent to flipping part of the serial chain about the corresponding diagonal vector while keeping the other part fixed, such as depicted in FIG. 18. It is easy to visualize that in this flipping process, no links are stretched or compressed and the loop is maintained. So effectively there is no constraints on dihedral angle parameters of a loop. Similarly, changing the orientation sign of non-singular anchored triangles amounts to flipping the triangle from one side to the other side, such as illustrated in FIG. 17, where the loop deformations in subfigures A H have the indicated values of link lengths l and diagonal lengths r̅ in common, and run in turn through all 8 possible values of orientation signs s̅, for the given planar 5-bar loop. Therefore, in our anchored triangle parameter system, the length parameters and triangle orientation parameters are uncoupled, for both the spatial case and the planar case. And the loop closure constraint is imposed on the length parameters only. In particular, for non-singular deformations of an n-bar loop, we can write down the set of feasible orientation parameters as follows.
DFlip³=(S¹)ⁿ⁻³,DFlip²={+,−}ⁿ⁻² (23)
where DFlip^{d}, d=2 or 3 is for a loop in d-dimensional Euclidean space.
The Set of Feasible Anchored Diagonal Lengths: DStretch[T]

Now we will formulate the loop closure constraint with respect to our length parameters (l v̅[T], r̅[T]), for a loop with a construction tree from triangles, T. As said earlier, with respect to simplex-based parameters, we formulate loop closure constraints as constraints on lengths parameters needed for successfully forming the simplices in a construction tree. In the case of a loop system, we see that a value of (l v̅[T], r̅[T]) is feasible (corresponds to some valid loop deformation) if and only if that value and all other given fixed link lengths allow the successful construction of the n−2 triangles: if some entries of (l v̅[T], r̅[T]) are too big or too small, one or more triangles will be impossible to construct. More precisely, from basic geometry we know that three lengths l1, l2, l3≧0 are the side lengths of a possibly degenerate triangle if and only if l1≦l2+l3, l2≦l3+l1, and l3≦l1+l2; furthermore, the triangle is non-degenerate if and only if all three inequalities are strict.

Denote the three vertices of Tri([)T](j) by P(j₁), P(j₂), P(j₃). Their interpoint distances must satisfy the following triangle inequalities.
Ineq_{[T](j)}¹:d(j₁,j₂)−d(j₂,j₃)−d(j₃,j₁)≦0
Ineq_{[T](j)}²:d(j₂,j₃)−d(j₃,j₁)−d(j₁,j₂)≦0,j=1, . . . , n−2
Ineq_{[T](j)}³:d(j₃,j₁)−d(j₁,j₂)−d(j₂,j₃)≦0 (24)

There are equivalent expressions for triangle inequalities. For example, one set of expressions uses the relationship between the minimum and maximum values of three side lengths. Denote the minimum and maximum values of d(jᵢ, jₖ) by dl(jᵢ, jₖ) and du(jᵢ, jₖ). As it is required of all distance values, all the bound values are non-negative. Then the minimum and maximum values of a side length can be expressed as functions of the bounds of the other two side lengths, as follows. In essence, this constraint formulation uses interval arithmetics and take into account the non-negative and triangle inequality constraints on side lengths.

$$\begin{matrix} du ( {j}_{1} , {j}_{3} ) = du ( {j}_{1} , {j}_{2} ) + du ( {j}_{2} , {d}_{3} ) & ( 25 ) \\ dl ( {j}_{1} , {j}_{3} ) = \{ \begin{matrix}dl ( {j}_{1} , {j}_{2} ) - du ( {j}_{2} , {j}_{3} ) & if dl ( {j}_{1} , {j}_{2} ) > du ( {j}_{2} , {j}_{3} ) \\ dl ( {j}_{2} , {j}_{3} ) - du ( {j}_{2} , {j}_{3} ) & if dl ( {j}_{2} , {j}_{3} ) > du ( {j}_{1} , {j}_{2} ) \\ 0 & otherwise\end{matrix} & ( 26 )\end{matrix}$$

Yet another equivalent formulation of triangle inequality constraints requires the Cayley-Menger determinant of the 3 points belonging to a triangle to be non-negative.

$$C M D ( {j}_{1} , {j}_{2} , {j}_{3} ) = 2 {( \frac{- 1}{2} )}^{3} \vert \begin{matrix}0 & 1 & 1 & 1 \\ 1 & 0 & D ( {j}_{1} , {j}_{2} ) & D ( {j}_{1} , {j}_{3} ) \\ 1 & D ( {j}_{2} , {j}_{1} ) & 0 & D ( {j}_{2} , {j}_{3} ) \\ 1 & D ( {j}_{3} , {j}_{1} ) & D ( {j}_{3} , {j}_{2} ) & 0\end{matrix} \vert \geq 0 \qquad ( 27 )$$

Note that for triangles in a construction tree for a loop, each triangle includes at least one diagonal and may include up to two links, which may have fixed or variable lengths. For any distance terms with fixed values, we can move them to the right-hand side of the inequalities and then organize the inequalities of all triangles into a matrix format

$$A [ \begin{matrix}l \overline{v} \\ \overline{r} [ T ]\end{matrix} ] \leq \overline{b} [ T ] . \qquad ( 28 )$$

For a loop and one construction tree from triangles, denote the (possibly empty) set of all feasible values for changeable link lengths and diagonal lengths by DStretch[T]. In other words,
DStretch[T]={(l v̅, r̅[T])|(l v̅, r̅[T])satisfying constraints (8) and (28)} (29)

To further illustrate the constraint formation, let us use the anchored triangle construction again as an example and take the advantage of the simple index scheme for this type of trees. To simplify the example and focus on the triangle inequality constraints, let us assume that all links have fixed lengths. Thus l v̅ is a null vector. Recall that a loop with n links has n−2 anchored triangles Tri([)a](j), j=1, . . . , n−2, with Tri([)a](j) having its vertices at joints P(a), P(a;j), P(a;j+1). Thus the three sides of an intermediate Tri([)a](j) are diag[a](j−1),diag[a]((j) and link(a;j), with their lengths being r[a](j−1), r[a](j), l(a; j). Each of the two end triangles, Tri([)a](1) and Tri([)a](n−2) has one diagonal and two links. Taken together these inequalities for Tri([)a](1), . . . , Tri([)a](n−2) give an explicit description for the set of all feasible r̅[a], which we call DStretch[a], in terms of the link lengths l(0), . . . , l(n−1): it is the set of solutions (r[a](1), . . . , r[a] (n−3)) of the following system of linear inequalities Ineq_{[a](j)}^{σ}. (where Ineq_{[a](j)}^{σ}, σε{+, −, ⊥} indicates a triangle inequality contributed by Tri([)a](j): Ineq_{[a](j)}⁺ and Ineq_{[a](j)}⁻ define anti-parallel half-spaces, to which that defined by Ineq_{[a](j)}^{⊥} is perpendicular.)

$$\begin{matrix}{Ineq}_{[ a ] ( 1 )}^{+} : & r [ a ] ( 1 ) \leq l [ a ] + l ( a ; 1 ) \\ {Ineq}_{[ a ] ( 1 )}^{-} : & - r [ a ] ( 1 ) \leq - \vert l [ a ] - l ( a ; 1 ) \vert\end{matrix} \\ \begin{matrix}{Ineq}_{[ a ] ( j )}^{+} : & r [ a ] ( j ) - r [ a ] ( j - 1 ) \leq l ( a ; j ) \\ {Ineq}_{[ a ] ( j )}^{-} : & - r [ a ] ( j ) + r [ a ] ( j - 1 ) \leq l ( a ; j ) \\ {Ineq}_{[ a ] ( j )}^{⊥} : & - r [ a ] ( j ) - r [ a ] ( j - 1 ) \leq - l ( a ; j )\end{matrix} \} j = 2 , … , n - 3 \\ \begin{matrix}{Ineq}_{[ a ] ( n - 2 )}^{+} : & r [ a ] ( n - 3 ) \leq l ( a ; n - 2 ) + l ( a ; n - 1 ) \\ {Ineq}_{[ a ] ( n - 2 )}^{-} : & - r [ a ] ( n - 3 ) \leq - \vert l ( a ; n - 2 ) - l ( a ; n - 1 ) \vert\end{matrix} \qquad ( 30 )$$

Rewritten in matrix format, system ((30)) becomes
DStretch[a]={ r̅[a]|A r̅[a]≦ b̅[a]} (31)
where b̅[a] is the column vector of the right hand side terms [l[a]+l(a; 1), . . . , −|l(a; n−2)−l(a; n−1)|]′ and ≦ is applied termwise. Each row of A corresponds to an inequality Ineq_{[a](j)}^{σ} in ((30)). We again emphasize that the non-appearance of l v̅ in definition (31) is due to our assumption that no link length is changeable. Also in ((30)), we just write two inequalities for each of the two end triangles, taking advantage of the two known side (link) lengths. It is also straightforward to write three inequalities for each of the two end triangles. Instead of using {1, 2, 3} as in ((24)), we use {+, −, ⊥} to label the triangle inequalities. Again, usages of particular symbols for the labeling (naming) purpose does not affect the nature of the intrinsic properties of the labeled entities.

For DStretch(T) as defined in (29), we only include the triangle inequalities and link length range intervals. If there are any additional constraints, the overall definitions on the set of the feasible length parameters should include those additional constraints. In the rest of the discussion, we will however still use DStretch(T) as defined in (29), to focus our description on loop closure related constraints. It is obvious for those skilled in the art how to include some additional constraints, such as range intervals on some diagonal lengths, in a revised definition of DStretch(T) and to still use our approaches and results below. Furthermore, other constraints can be dealt with in the divide-and-conquer approach described earlier.

Each triangle inequality defines a closed half space; so does each length bound constraint. So as the intersection of the closed half-spaces determined by the constraints, DStretch[T] must be a (possibly empty) convex polytope. If the changeable link length intervals also make all the diagonals and changeable link lengths to have finite upper bounds, then DStretch[T] is a convex polyhedron. Note that we don't have to require lower bounds, since the triangle inequality constraints already restrict the length values to be non-zero, i.e., have a lower bound of 0. Just as an example, if all the links of an n-bar loop have fixed lengths, then all the diagonals have finite bounds and DStretch(T) is a convex polyhedron generally having dimension n−3. FIG. 19 shows a three dimension convex polyhedron DStretch for a 6-bar loop, and its the bounding box. If all link lengths of an n-bar loop are changeable and no link length is upper bounded, then DStretch[T] is an (2n−3) convex polytope, in fact, a convex polygonal cone.

DStretch Stratification

There are many geometrical features associated with polygonal objects, such as their faces, edges and vertices. For our set of feasible diagonal lengths and link lengths, DStretch[T], its geometrical features further have physical meanings related to loop deformations. Before describing the physical interpretations, let us review some basic concepts in stratification, which would be useful for our description.

We recall a few definitions from the mathematical theory of stratifications. Suppose X is a subset of Euclidean space RN. A partition S of X into subsets M₁, . . . , MK is a stratification in case: (1) Mᵢ∩Mⱼ=∅ for i≠j; (2) each Mⱼ is a connected smooth submanifold of R^{N}; and (3) for each i the closure cl(Mᵢ) of Mᵢ is itself the union of some of the Mⱼ. Each Mᵢ is called an S-stratum. For (i≠j), Mᵢ and Mⱼ are incident if Mᵢ⊂cl(Mⱼ) or Mⱼ⊂cl(Mⱼ). The dimension dim(X) of X is max{dim(Mᵢ)|i=1, . . . , K}; the codimension codim(Mᵢ) of Mᵢ is dim(X)−dim(Mᵢ). If codim(M)=0 then M is an open subset of X (in the topology induced on X by R^{N}); if X is connected then X is the closure of the union of the codimension-0 S-strata.

Simple but paradigmatic examples of stratifications come from convexity theory. Let P⊂C R^{N} be a convex polyhedron, i.e., a closed bounded subset of R^{N} that is the intersection of finitely many closed half-spaces. The dimension dim(P) of P is the dimension of the unique smallest flat (i.e., translated linear subspace of R^{N}) containing P; the relative interior of P is its actual (topological) interior as a subspace of that flat—equivalently, the set of all points of P not contained in a face Q of P with dim(Q)<dim(P). The partition of P into the relative interiors of all its faces is a stratification we call the face stratification SFace of P. Each SFace-stratum Q is convex, as is cl(Q); P has exactly one codimension-0 SFace-stratum.

Below we make extensive use of the face stratification SFace for DStretch[T]. For an n-bar loop and a construction tree from triangles T, define the set of all (j, k) appearing in labels Ineq_{[T](j)}^{k} of ((24)) as its Triangle Mode,
TM={(j,k),j=1, . . . , n−2,k=1,2,3} (32)
Under this spirit of the definition above, when using the notation in ((30)) for a construction tree of anchored triangles having anchor a, the loop triangle mode is
TM={(1,+),(1,−),(n−2,+),(n−2,−),(j,+),(j,−),(j,⊥),j=2, . . . , n−3}.
In the following, we will use the TM notation as defined in ((32)) in our general description but also use the above notation for anchored triangles in our examples.

If Ineq_{[T](j)}^{k} of an anchored triangle Tri ([)T](j) becomes equality, we say that the triangle Tri([)T](j) is in singularity mode k. Note that except for doubly degenerate triangles, each triangle can be singular in at most one mode. In other words, only one of the two or three linear inequalities Ineq_{[T](j)}^{k} in ((24)) associated with triangle j may be replaced with the corresponding equality Eq_{[T](j)}^{k}. If an anchored triangle is not singular, it is not in any of its singularity mode; or we can say that its singularity mode is empty φ. A singularity mode of a triangle determines a specific way for the triangle to degenerate into a line segment. For example, when the singularity mode of an anchored triangle Tri([)a](j) is +, −, or ⊥, joint P(a; j+1), P(a; j) or P(a) is the interior (not the end) point of the line segment arising from the degenerate Tri([)a](j).

The singularity pattern of a deformation D with respect to a tree from construction T, SP_{D}[T], is the set of the singularity modes of its singular triangles. We also use E_{D}[T] to refer to a singularity pattern of deformation D with respect a tree from construction T. In other words,
SP_{D}[T]=E_{D}[T]={(j,k)|Tri([)T](j) singular in mode k at deformationD} (33)

The singularity pattern of a deformation, with respect to a construction tree T, is completely determined by its length parameter values l v̅ and r̅[T], since these length variable values, along with all other fixed link lengths, completely determines the shapes of all anchored triangles, with the singular ones degenerate into line segments in some specific ways. In other words, for a loop with given link lengths and a construction tree T, (l v̅, r̅[T]) completely determines the singularity modes of all triangles used in the construction and thus the singularity pattern. Therefore, it makes sense to talk about singularity pattern just with respect to the length parameters, SP_{(l v̅,r[T])[T], or E}_{(l v̅, r̅[T])}[T]. The number of elements in E_{(l v̅, r̅[T])}[T] is the number of degenerate triangle inequality induced by (l v̅, r̅[T]); and we will call this number the singularity depth of (l v̅, r̅[T]) with respect to tree T and denote it by e_{(l v̅, r̅[T])}[T].

For certain problems, it is possible that one construction tree T1 is used for triangular parameters and a different tree T2 is used for specifying a singularity pattern. In other words, we want to talk about SP_{(l v̅,r[T1], τ̅[T1])[T2}]. One method for solving this problem is to first compute the point Cartesian coordinates, based on the parameter values (l v̅, r̅[T1], τ̅[T1]), then compute a new set of triangular parameter values with respect to Tree T2, r̅[T2], τ̅[T2], and finally consider SP_{(l v̅, r̅[T2])}(T²).

In the rest of the description, we will focus on problems of using one construction tree in the description and computation of singular configurations. Using one construction tree for both parameter definition and singularity specification has advantages. For example, all r̅[T] belonging to one stratum Q of DStretch[T] that is defined by some degenerate triangle inequalities induce the same singularity pattern SP[T], which is also different from the singularity patterns of all other stratum. So the singularity pattern and singularity depth of a DStretch[T] stratum is well defined, and we will use SP_{Q}[T](or E_{Q}[T]) and e_{Q}[T] to denote the singularity pattern and singularity depth of stratum Q[T].

For a loop with generic link lengths, the singularity depth of a stratum Q is equal to the co-dimension of the stratum; but the singularity depth of a stratum for a loop with non-generic link lengths may be different from its co-dimension. The following results show that E_{Q} can be used to label the SFace-strata of DStretch defined by degenerate triangle inequalities, and derive their incidence relations:] [a E_{Q}≠E_{Q′} if Q≠Q′; [b E_{Q}⊂E_{Q}′ if Q′⊂cl(Q); [c codim(Q)≦e_{Q}; and [d codim(Q)=e_{Q} if e_{Q}≦1.

FIG. 20A. shows the DStretch[ ] for a 5-bar loop having link lengths (100, 42, 37, 95, 86), along with the singularity patterns for all DStretch[0] strata. This set of link lengths is generic; and the vertices have the same singularity depths and codimensions, which are 2. On the other hand, the set of link lengths (2, 3, 4, 2, 3) is not generic, since 2+3−4+2−3=0. FIG. 21A. shows DStretch[0] for a 5 bar loop having this set of link lengths. Note that two vertices have singularity depth 3 and their codimensions, like all other vertices, are 2. Since the singularity depth of a vertex of DStretch[T] of an n-bar loop is at least its codimension n−3, it corresponding length value can induce singularity to at least n−3 triangles, leaving at most one triangle non-degenerate. FIG. 43 illustrates several system deformations of a 5-bar loop, where the ones ones with only one non-degenerate triangle have their diagonal lengths corresponding to vertices of DStretch, and the only one with all triangles non-degenerate has its length values equal to the average of the vertex length values and corresponds to a centroid of DStretch.

DSpace Connectivity and Geometry

Our invention improves prior art for describing, parameterizing, generating, modifying, optimizing, manipulating and path planning deformations of loops, in many ways, one of which is that we provide an explicit, efficiently calculable stratification of DSpace into copies of a single convex tile. Here, a stratification is in general a decomposition into finitely many smooth connected pairwise disjoint manifolds called strata, of various dimensions. Stratifications of manifold spaces (such as DSpace) always exist in theory; but there is no obvious coordinates, especially coordinates that cover large subset of all deformations, as ours.

In addition, a particular advantage of our invention is that we construct stratifications in a very practical way. In general, the strata of a stratification may be individually difficult to describe or to traverse, and the manner in which the totality of the strata are assembled to make the entire stratified manifold may be combinatorially complex. But our invention gives practical and efficient procedures to describe, traverse, and reassemble our strata, using the power of convex geometry.

In short, in our new parameters, DSpace[T] of an nS loop parameterized with a construction tree T, loosely speaking, can be identified with DStretch[T]×DFlip³, with proper understanding of singular deformations. Since DStretch[T] is convex, DFlip³ is a torus and can be identified with a cube, under proper face identification. And a cube is convex, so we call DSpace [T] of an nS loop is practically convex. And a nice property of convex sets is that, for any two points in a convex set, a linear interpolation between the points stay in the set and defines a valid straight line path between the two point. Therefore, to planning a path between two specified deformations of a spatial loop, we develop an efficient method which computes the values of the triangle-based length and relative orientation parameters of the two deformations, if not provided, and uses the linear interpolation of the parameter values to create a straight line path for the two deformations. FIG. 24 shows a linear path between two deformations of a spatial 1000S loop, generated by our methods.

DSpace [T] of an nR loop consists of copies of a convex polyhedron, again loosely identified with DStretch[T]×DFlip², with proper boundary identification gluing the copies. In particular, note that when a planar triangle Tri([)T](j) degenerates into a line segment, our usual definition of orientation sign such as the one in ((16)) will give an sign value of zero (0). But a degenerate triangle, with no well-defined orientation, can also be labeled with orientation sign + or −. That explains the notation of identifying DSpace[T] of a loop with DStretch[T]×DFlip².

For a planar loop and a particular construction tree, a stratum Q of DStretch, E_{Q} identifies which triangles, if any, are degenerate for any given r̅εQ. In other words, if (j,σ)εE_{Q}, and r̅εQ, then Tri(j) is degenerate in any deformation with that value of r̅, forcing s(j)=0 for such a deformation. On the other hand, if (j,σ)∉Q for any σε{1, 2, 3}, then Tri(j) cannot be degenerate in any deformation with that value of r̅, so s(j) must be + or − for such a deformation. This observation leads to another way to label the open face Q, namely, by an (n−2)-vector reflecting the possible s values of loop deformations with r̅εQ: the j^{th} component is the symbol ± if Tri(j) cannot degenerate, 0 if it must. FIG. 20B and FIG. 21B are labeled in this way.

In fact, DStretch with this type of labeling can also be viewed as a compact visualization of DSpace itself: each label is to be understood as a template in which the ±-signs take on all combinations of values + and −, and the different ways to fill in each template represent different “convex tiles”. The C and D subfigures of FIG. 20 and FIG. 21 show the orientation sign labeling of all strata, with clear correspondence with those labels in the corresponding B subfigures.

Further notice that a triangle in a construction tree with a positive orientation can only move to a negative orientation via some singular configuration with the triangle degenerating into a line segment, and vice versa. So the DSpace copies of a singular DStretch stratum, assumed to be singular in Tri(( )j), can be used to glue appropriate strata not singular in that triangle. More specifically, a DSpace stratum Q having 0 as it sign for Tri(( )j) serves a boundary gluing two DSpace strata, if they exist, that have either + or − for Tri(( )j) and same orientation signs for all other triangles as Q. Such a boundary identification is used to reconstruct the topology of the DSpace. In particular, FIGS. 20 E and F show that the DSpace of that 5-bar loop example can be identified with two tori. FIGS. 20 E and F show the partial construction of the DSpace of a 5-bar having link lengths (2,3,4,2,3). This set of link lengths is not generic, which complicates its DSpace structures around the vertices having unequal singularity depths and codimensions. To avoid cluttering the figure, we omit some details in the overall DSpace structure as shown in FIG. 22. FIG. 23 shows the DSpace of the same loop embedded in the cut-open 3-dimensional torus parametrized by 3 angles. The straightforward piecewise convex geometry of FIGS. 21 C and D contrasts with the very complicated geometry of FIG. 23.

For a planar loop with all link lengths fixed, its DSpace has only up to two connected components. DSpace has two connected components if the loop has 3 long links. Otherwise, it has only one connected component. For a loop with fixed link lengths, if the sum of the second-longest link length and the third-longest link length is strictly greater than the sum of the lengths of all other links, the loop has 3 long links. Otherwise, it does not have 3 long links. A planar loop with 3 long links has only one triangle that can never degen

For planning between two specified deformations of a planar loop, we first compute their length and orientation sign values. If the orientation signs for their non-singular triangles are equal, the two deformations belong to the closure of one DSpace stratum, which is convex. So we can use linear interpolation of their length values to generate a linear path in the convex set. FIG. 25 shows such a linear path between two deformations of a planar loop. But if at least one triangle is non-singular and has opposite orientations at the two deformations, that triangle needs become degenerate in the motion process. For this case, the two deformations do not belong to a convex set; and a path connecting the two deformations, if exist, has to pass through some singular strata connecting the strata where the two specified deformation belong. So our method in this case is to find a sequence of critical intermediate deformations needed for connecting the two specified deformations, with each critical deformation achieving singularity at one or more triangles of those having opposite orientation signs at the two specified deformation. We use the two specified deformations and the critical intermediate deformations to form a milestone path, with each two adjacent milestone deformations belonging to the closure of one stratum. If we need to generate a detailed path, we use a linear path between every two adjacent milestone nodes to create a piece-wise linear path between the two specified deformations. FIG. 26 shows a milestone path between two deformations of a 5R loop, which has opposite orientations in all three triangles. For the clarity of figure, we don't show the linear path. A milestone path like this fully encodes all information of its corresponding piece-wise linear path.

For this particular example, we used 3 intermediate deformations, each having singularity depth 1 and inducing singularity to one triangle. Singular deformations having more singularity depth can induce singularity to several triangles simultaneously and can be used to generate milestone paths with fewer intermediate deformations. In particular, a vertex of DStretch of a n-bar loop can induce singularity to at least n−3 triangles simultaneously; and an n-bar loop has a total of n−2 triangles in its construction tree. As described earlier, for a planar loop having all link lengths fixed and 3 long links, one triangle cannot become degenerate. So any vertex of its DStretch can induce singularity to all other degeneratable triangles. This means that, for such a loop, any two deformations in one connected component of the DSpace can be connected by using one intermediate deformation with its length value corresponding to a vertex of DStretch. As for a planar loop that have all link lengths fixed and does not have 3 long links, its DSpace is connected into one component and any two deformations can be connected by using only two critical deformations, one having its length parameters corresponding to a DStretch vertex and thus inducing singularity to at least n−3 triangles, and the other inducing singularity to the only triangle, if exist, that is not singular at another critical deformation. We have methods that efficiently generate these critical intermediate configurations. Further, if there are a lot of motion planning problem to be done to a loop system, we can generate a set of critical deformations in some pre-processing step. Then motion planning between two specified deformation can be solved by efficiently picking intermediate deformations from the previously generated set.

Singular Configuration Parameterizations

The singularity of deformations as parametrized by our triangle parameters is relative to some particular construction tree. A deformation may be considered singular for one tree while non-singular for another one. FIG. 14 shows two deformations of a 7-bar loop: neither is singular for the tree using anchored triangles with P(2) as the anchor, but both are singular, and the one in gray is also supersingular, for the tree of P(0)-anchored triangles. But the singularity property of a loop is the same with respect to trees that use a same set of triangles.

We have two approaches to address the parameterizations of singular deformations: one is to switch to a tree using a different set of triangles and the other is to continue to use the same tree but adjust parameters.

Parametrization with Different/Multiple Triangulation(s)

One way for dealing with a loop deformation singular for one set of triangles is to switch to another set forming a construction tree of the loop. If the deformation becomes non-singular for this new tree, the triangular parameters as originally defined become well-defined.

Mathematically, we can consider one choice of construction tree of triangles along with the corresponding triangular parameters as a local coordinate chart for DSpace that covers the set of all non-singular deformations with respect to that set of triangles. Using this view, changing of construction trees and triangles for a singular deformation follows the general practice in manifold parameterizations in terms of using a different coordinate chart for a point that is problematic (singular) for one original chart.

Since a convex n-sided polygon has Catalan(n−2) unique triangulation, each n-bar loop has multiple unique sets of triangles, with each set forming an triangle adjacency graph, which is a tree and can be used to constructing various related construction trees. Each construction tree gives us a local coordinate chart covering (at least) the set of non-singular deformations w.r.t. that tree. Therefore, our approach provides a family of piecewise practically convex parameterizations for loops. And the union of these coordinate charts covers the set of loop deformations that are non-singular with respect to at least one set of constructing triangles.

$$DNS = {{⋃}^{total trees}}_{j = 1} DNS ( {T}_{j} ) \qquad ( 34 )$$

Of course it is possible that for a loop with some given link lengths, every choice of trees may have some loop deformations classified as (super) singular with respect to it. In that case, no choice of tree will make it possible to use that set of triangular parameters to parameterize the whole deformation space of the loop. In other words, a deformation is not covered by the charts of this atlas if and only if it is singular with respect to every tree. Clearly these very special deformations, if they exist, form a set with much lower dimension than DSpace (except for trivial cases). For these special deformations, we can use the ideas described next, such as the alternative definitions of the dihedral angles and the sub-loop concepts, to derive their parameters.

Preferences of local coordinates from the atlas are likely to be task dependent. For example, if we know a priori some deformations in some addressed problems, such as in the case of path planning where two query deformations are given a priori, it would be generally more convenient to find a chart that covers these deformations. We also note that the trees of anchored triangles used in our examples do have the virtues of being easy to generate and label, as well as some advantages to be explained later.

Parameter Adjustment for a Fixed Triangulation

The approach mentioned earlier largely avoid the problem of parameterizing singular deformations. But in some cases, we need to work on deformations of required singularity, such as the deformations singular at some specified triangles needed for connecting two planar nR loop deformations with opposite orientations in those specified triangles. Then it would be better to include those triangles in a construction tree, if possible, and explicitly model the required singularity. Next we consider how to adjust our triangular parameters to properly parametrize singular deformations.

The modification is simple for a deformation that is singular but not super-singular. Assume Tri([)T](j) of a triangulation T is singular for a loop deformation. Just for the sake of computation purpose, we can choose any unit vector in the well-defined plane perpendicular to the line segment of the degenerate triangle as its normal n[T](j). In practice, we can make some convenient choice such as by setting n[T](j) to the normal of one of its neighboring triangles when applicable. However, notice that for a given singular deformation, different choices of n̅[T](j) will lead to different values of the dihedral angles involving this triangle.

Another way for dealing with the situation is to define one diagonal length and dihedral angle for every two adjacent non-singular triangles, instead of for every two adjacent triangles. We note that the common edge of two adjacent non-singular triangles in a construction tree of triangles is a diagonal, with respect to which the diagonal length and a dihedral angle is well-defined. So if a deformation of a spatial loop has K non-singular triangles in the triangulation, it has K−1 well-defined independent diagonals and can be described by 2(K−1) parameters, with the maximum value of K being n−2 for an nS loop. Therefore, each singular but not-super singular triangle leads to a reduce of two parameters. This reduction can be understood as follows: each such triangle will correspond to one and only one triangle inequality to become equality (only one because the deformation is not super singular and thus all side lengths are positive), which reduce the number of length parameters by one. Also note that for two adjacent non-singular triangles, rotating one about their shared diagonal will lead to new deformations of the pair. But when at least one of the two adjacent triangles is singular, the relative rotation between the pair does not lead to any new deformations of the pair and thus loses one torsional degree of freedom.

We would like to emphasize that for the convenience of computation as afforded by a constant number of parameters, it is okay to use the original triangular parameters for singular but not super-singular deformations, with the proper understanding of the diagonal lengths and dihedral angles involving singular anchored triangles.

If a deformation is super-singular, each length-0 diagonal corresponds to two joints coincident with each other and partitions the loop into two subloops sharing a vertex. In general a super-singular loop deformation can be viewed as consisting of m subloops, each sharing a vertex with some other one(s), and none being super singular. FIG. 27 shows an deformation having 4 subloops. Such a loop deformation can be parametrized by [a] triangular parameters for the m subloops (as described earlier for non-super-singular loops) and (b) (m−1) set of parameters for the relative deformations between subloops sharing vertices, which will be referred to as inter-loop-DSpace. Regarding the relative deformation between two sub-loops sharing a vertex, it is easy to see that
if both sub-loops are non-trivial, meaning that each one has at least three non-collinear joints (i.e., one non-trivial triangle), their relative deformation involves their relative orientations, which can be identified by an element in SO(3).
if one sub-loop is nontrivial while the other one degenerates into a line segment, their relative deformation can be parameterized by the orientation of the line segment w.r.t. the other non-trivial loop, which can be identified by an element in S².
if both subloops degenerate into line segments, their relative deformation only involve the angle between the two line segments, which can be identified by an element in S¹.

### ADDITIONAL EXAMPLES

While simplices such as triangles and tetrahedra have been used in many geometrical related computation, it is important to restate that the prior usages of these entities to multipoint systems are restricted to those that can be decomposed into simplices, using the existing constraints and structures of the systems, such as the trilaterable manipulators mentioned earlier. In contrast, the existing constraints of the systems addressed in invention are not sufficient for defining the simplices. For systems allowing a tree construction from simplices, we do not follow the general practices of using the conventional parameters and we are the first to add additional diagonals needed for defining the simplices and use simplex-based parameters for system deformations. And against the widely held belief of the non-existence of good loop parameters for systems involving loops, we design these simplex-based parameters that are particularly suitable for a broad class of linkage systems. Therefore, our invention is very important for the addressed systems as well as all those systems including this type of systems as their subsystems. After an extensive description of the triangle-based parameters for single loop systems, we will next describe additional example systems to further illustrate the broad applicability and practical importance of our invention.

Multi-Loop Systems allowing tree constructions from triangles can benefit from our invention. Following our general principles of simplex-based approach as described in the beginning of the detailed description, we again use length parameters (still under the triangle inequality constraints) and orientation parameters such as dihedral angles and orientation signs for the deformations of a multi-loop system using a particular construction tree. In multi-loop systems, it is possible that two adjacent triangles share an edge or just a vertex. For either case, refer to our earlier description for orientation parameters for single-loop systems, including orientation parameters for super-singular deformations, which as described earlier, can be viewed as involving multiple loops sharing vertices.

FIG. 28 illustrates a construction tree of such a multi-loop system, which can be viewed as having two subloops sharing a chain of edges with its end joints being the leftmost and rightmost joints in the figure. For this system, we define a diagonal between the leftmost and rightmost joints, which effectively decompose the original system into three sub-loops as shown in the lower three figures. Each subloop allows a construction tree of triangles such as those shown in the figure. And subloop systems, each treated as one high-level unit, also form a simple tree of 3 nodes and 2 edges drowning in curved gray lines. So from a high-level tree having subsystems as their nodes and one construction tree for each subsystem, we create a construction tree for the original system. In general, this kind of hierarchical view and construction of simplex trees are useful for dealing with systems addressed in our invention.

Foldable Objects. Let us use the deformations of a system of facets incident on a vertex of a crease pattern of a foldable object, such as one shown in 10, as an example. Instead of dihedral angles and corresponding constraints as described earlier ((5)), we will show that such a system also allows a tree construction from simplices, tetrahedra in this class. And we use tetrahedra-related parameters for this system.

Denote a crease pattern vertex by O. Every two adjacent crease lines incident on it define a facet, and we assume all facets to be rigid. Then these rigid facets and crease lines define a polyhedral cone having its apex at 0. So we also call 0 the apex of the system. Each crease line corresponds to one edge of the polyhedral cone. The facets are allowed to rotate about the crease lines, without tearing up the system. Thus, the deformations of the polyhedral cone are subject to the loop closure constraints for keeping the facts and crease lines intact.

Now pick one non-apex point on each crease line, denoted by Pᵢ for the picked point on crease line i. We connect points on adjacent crease lines by line segments. Note that each line segment stays on one rigid facet and rotation about the cone edges don't deform the facets at all. So these line segments have fixed lengths. Therefore, these line segment form a loop with n rigid links. Also note that the distance between the cone apex O and any point Pᵢ remains fixed. This is because that all the cone edges intersect at the apex and rotations about cone edges do not change the distance between the apex and any point of the polyhedral cone, including those on the cone edges. So now we have a polyhedral cone (O, P₀, . . . , Pₙ₋₁), with fixed lengths between 0 and Pᵢ, and between Pᵢ and Pᵢ₊₁. Our objectives are to find a construction tree of simplices for it and use simplex-based parameters for its deformations.

Our method is to use any construction tree of triangles for the loop (P₀, P₁, . . . , Pₙ₋₁) We note that the apex 0 and three vertices of each triangle forms a tetrahedron, since there is an edge (of fixed length) between O and any P(i). Therefore, we use these tetrahedra, closely related to triangles in a construction tree for the loop (P(j₁), P(j₂), P(j₃)), to define a construction tree for the polyhedral cone (O, P₀, . . . , Pₙ₋₁). FIG. 29 shows an example of a hexa-cone and one construction tree of 4 tetrahedra, with the diagonals drawn in gray lines.

Again, following our general principles of simplex-based approaches described at the beginning of the detailed description, we define tetrahedra-based parameters for the deformations of a polyhedral cone allowing rotation about the edges as follows

the squared diagonal lengths D[T]=[D[T](1), . . . , D[T](n−3)], and

the tetrahedron orientation signs s[T]=[s[T](1), . . . , s[T](n−2)],

where T denotes the construction tree of simplices for the polygonal cone, and D[T](i)=d²[T](i) is the squared length of the i^{th} diagonal and s[T](i) is the orientation sign of the i^{th} tetrahedron defined by tree T.

We formulate the loop closure constraints of the facets of a cone as the constraints on the diagonal lengths required of successful formation of tetrahedra. As described earlier, the Cayley-Menger determinant of a set of n points is proportional to the volume of the simplex spanned by the points in n−1. Therefore, a necessary and sufficient condition for a set of lengths to form a tetrahedron, and more generally, an n-simplex in Rⁿ⁻¹, is to make the corresponding Cayley-Menger determinant to be non-negative. As an example, here is the condition on the squared distances of a tetrahedron formed by 4 points P(jᵢ), i=1, . . . , 4, with D(jᵢ,jₖ) denoting the squared distance between points P(jᵢ) and P(jₖ).

$$CMD ( {j}_{1} , {j}_{2} , {j}_{3} , {j}_{4} ) = 2 {( \frac{- 1}{2} )}^{4} \vert \begin{matrix}0 & 1 & 1 & 1 & 1 \\ 1 & 0 & D ( {j}_{1} , {j}_{2} ) & D ( {j}_{1} , {j}_{3} ) & D ( {j}_{1} , {j}_{4} ) \\ 1 & D ( {j}_{2} , {j}_{1} ) & 0 & D ( {j}_{2} , {j}_{3} ) & D ( {j}_{2} , {j}_{4} ) \\ 1 & D ( {j}_{3} , {j}_{1} ) & D ( {j}_{3} , {j}_{2} ) & 0 & D ( {j}_{3} , {j}_{4} ) \\ 1 & D ( {j}_{4} , {j}_{1} ) & D ( {j}_{4} , {j}_{2} ) & D ( {j}_{4} , {j}_{3} ) & 0\end{matrix} \vert \geq 0 \qquad ( 35 )$$

The above inequalities degenerate into 0 if and only if the tetrahedron degenerates and has all 4 vertices in one plane. Therefore, we define the set of feasible squared diagonal lengths as
DStretch={D(T)|D(T) satisfying constraint ((35)), for j=1, . . . , n−2} (36)

As for the tetrahedron orientation signs, similar to the orientation sign values for triangles in a construction tree for a loop, we can use +, − for the two orientations of non-degenerate tetrahedra, and 0 for singular tetrahedra. We can also use more detailed labels for different types of singularity. If we allow a singular tetrahedron to be labeled with either + or − as its orientation sign, we can roughly identify DSpace[T] of the polygonal cone parametrized by the tree T of tetrahedron DStretch[T]×DFlip, where DFlip={+, −}ⁿ⁻², again with proper understanding of the parts involving singular deformations. Such a DSpace parameterization is very similar to that of a planar loop with n links. For the polyhedral cone system with n rotatable edges, its DSpace under the tetrahedron-based parameters is generally a union of 2ⁿ⁻² copies of a certain piecewise smooth, semi-algebraic body DStretch[T] of dimension n−3 defined by non-negativity of Cayley-Menger determinants. So again, the deformation spaces of polygonal cones a stratified deformation space structure.

Multi-Fingered Robotic Hand Manipulation Systems

Multi-fingered robotic hands have potential great impact in widely varied areas (service, manufacturing, and extractive industries; mapping and exploration in extraterrestrial, undersea, and other hostile environments; search and rescue; etc.) and been actively research on. Yet robot manipulation has so far seen relatively limited applications. Major obstacles to progress appear to be the complexity of general manipulation problems and the lack of efficient computational algorithms.

Manipulation systems are linkages containing loops. FIG. 30 depicts a human hand manipulation gating from one two-finger grasp to another via a three-finger grasp. Robotic hands also use similar motions in manipulating objects. Here, a manipulation system can move an object with a fixed grasp (without changing grasping points), and then change to another grasp, for example in order to replace a finger that reaches its joint limits with another grasp, before further moving the objects. As demonstrated with overlapping linkage models in FIG. 30, grasping systems are linkage system containing loops, with the grasped object serving as virtual link(s) to form loops with finger links. Each two-finger grasp involves one loop, and we can apply our general approach described above for this kind of system. A three-finger grasp corresponds to a considerably complex linkage model. So we will describe its construction tree from simplices next.

Denote the fixed base points of the fingers by A(0), A(1), A(2), and denote by B(i) the grasping point of the finger based at A(i). Assume the grasping points are at general positions and do not change. So B(0), B(1), B(2) defines a rigid triangle. Since the base points of fingers are assumed to be fixed, the three points A(0), A(1), A(2) also define a rigid triangle and we will call it wrist as to give it an intuitive name. Now define one end-to-end diagonal for each finger from its base to its grasping point, as shown in FIG. 31A. We will refer to such a diagonal by its two end points, like (A(i), B(i)).

Each diagonal forms a loop with the finger links. Following the hierarchical view of systems and trees described at the multi-loop example, we use the three end-to-end diagonals of the fingers to define three loops, one for each finger, and a triangular prism system between the grasp object and the wrist with three diagonals (A(i), B(i) as its virtual links. Note that a human finger can generally be modeled as a planar chain with a spatial spherical joint at its base and revolute joints between finger links. So we model each of the finger loops, formed by finger links and a corresponding end-to-end diagonal, as a planar loop and uses a construction tree of triangles for it. As for virtual triangular prism defined by the three diagonals (A(i), B(i), we further define three diagonals, such as between A₁ and B₀, A₂ and B₀, and A₂ and B₁ as shown in FIG. 31B, to form a construction tree of tetrahedra for the triangular prism.

Therefore using this approach, we create a construction tree of simplices, including both triangles and tetrahedra, for the original grasping system, such as one shown in FIG. 31D. Then we define our simplex-based deformation parameters for this system to be the length parameters for the triangles and tetrahedra (again under triangle inequality and Cayley-Menger determinant constraints), as well as, orientation parameters for adjacent simplices. Just as an example to illustrate the smooth property of the Cayley-Menger Determinant constraint, FIG. 31C shows the set of the feasible squared lengths of diagonals (A₁, B₀), (A₂, B₀), and (A₂, B₀), assuming some fixed values for other three diagonals of the triangular prism (Aᵢ, Bᵢ), i=0, 1, 2.

FIG. 32 shows another multi-point model for 3-finger grasps, along with a construction tree of it from triangles.

Variations and Applications

While our above description contains many specificity=ies, these should not be construed as limitations on the scope of invention, but rather as some representative exemplification thereof. Many other variations are possible. For example, for a construction tree of triangles, we use diagonal lengths and changeable link lengths as the parameters for the shapes of the triangles in above examples. We can also use squared lengths, and more generally, some powers of the lengths, as the simplex shape parameters. FIG. 33 shows such an example. For a 5-bar loop having all link lengths fixed and a construction tree of anchored triangles, subfigure A describes the set of feasible diagonal lengths, and subfigure B describes the set of feasible squared diagonal lengths. Note that, in both subfigures, we use r(j), j=1, 2 as the axis labels. But the r(j)'s in subfigure A are diagonal lengths, while those in subfigure B are squared diagonal lengths. And internal labeling term r(j) 2 in subfigure B corresponds to r(j) in A, which explains the correspondence among the equations in the two subfigures.

Take a spatial loop as another example. In our earlier description, we use a construction tree of triangles for such a loop, and uses length parameters and relative orientation parameters of the simplices as the loop deformation parameters. But instead of a tree of triangles, we can also define a construction tree of tetrahedra for such a system. We note that every two adjacent triangles in an initial triangle construction tree share one diagonal and thus two points. For each adjacent triangle pair, it has other two points, one from each triangle and not on the common diagonal. We define an additional diagonal between these two points and use this diagonal as well as the links and diagonals of the two triangles to define a tetrahedron. In essence, we replace each dihedral angle by an newly defined diagonal. This way, we can generate a construction of tetrahedra for a loop, as shown in FIG. 34 for a spatial 6S loop. Using a construction tree of tetrahedra, we define the tetrahedra-based loop deformation parameters as the squared lengths (to facilitate Cayley Merger determinant constraint formulation) and tetrahedron orientation signs.

Alternative parameters, built upon our simplex-based parameters, are within the scope of the invention. For example, it is generally desirable to formulate a constraint as a convex constraint in some parameters, so that the set of feasible values of the parameters is convex. Parameters forming a convex set have many advantages over those that are not convex. For example, given two points in a convex set, a linear path between them stays in the convex set and thus form a valid path between two points. On the other hand, if a set is not convex, such as a circular pie with part of its interior cut out, there may not be a straight line path between some point pair since the line goes through the cutout area and thus is invalid. Based on convexity theory, many mappings preserve the convexity. Mathematically, this means that, given a convex set X={x|xsatisfiessomeconstraints}, there exist functions defined over X, for now denote one such function by f, such that image sets, such as f(X)={f(x)|xεX} of f, are still convex. There are well known general mapping that preserve set convexity, such as affine transformation functions and perspective functions. Specific convex sets may have additional convex-preserving mappings, characteristic of the properties of the convex sets. In our examples above, many length parameters are under convex constraints, such as length parameters under the triangle inequality constraints. A convexity-preserving mapping of our length parameters can generate alternative parameters that still have their feasible values form a convex set. These alternative parameters are based on our simplex-based parameters and the teaching of this invention and are certainly within the scope of the invention.

We have focused our earlier descriptions on simplex-related constraints, such as the simplex formation constraints (Cayley-Menger type constraints over length parameters), link length limit constraints, and simplex singularity constraints (again over length parameters). Here we give a few more examples to show the broad applicability and importance of simplex-based parameters and our invention. For example, assume two adjacent links pf fixed lengths, link (P(i−1), P(i)) and link ((P(i), P(i+1)), need needs to maintain the angle between to stay certain specified interval. Also assume that there is a diagonal between P(i−1) and P(i+1). Instead of using the angle constraint directly, we formulate an equivalent range constraint in the diagonal length, which can readily by our simplex-based parameters.

Consider link length uncertainty as another example. Assume that some link length l(k) has an uncertainty range of [l(k), l(k)]. While this information can be used in many ways, here we just show how to find a (possibly empty) set of diagonal length values that are guaranteed to be able to close a loop for arbitrary l(k) in its uncertainty range. Assume that len(i) and len(j) are the lengths of other two sides that need to form a triangle with l(k) in a construction tree of simplices for a system under study. Then we can use the following constraint to conservatively enforce the triangle inequality. The same spirit can be used for a triangle involving multiple links having uncertainly in their lengths.
l̅(k)≦len(i)+len(j)
len(i)≦len(j)+l(k)
len(j)≦len(i)+l(k)

Also note that, while we focus on deformations in our earlier descriptions, we extend simplex-based deformation parameters with rigid motion parameters to form simplex-based parameters for system configurations.

For systems addressed in our invention, our methods are very helpful not only for operating upon existing systems but also for designing new systems. An important step in system design is to find out the properties of some tentative designs and then further improve on them if needed. For design of linkage systems such as manipulators, properties of the configurations spaces of tentative designs, such as their topology, geometry, and distribution of configurations having specified properties are particularly helpful. Some evaluation criteria require generation of system configurations, sometimes as samples throughout the configuration space, followed by computation of some figure of merit numbers at each sample point, and then analyze the distribution of the merit values. For the system addressed in our invention, the simplex-based parameters are very effective for these analysis tasks involving tentative designs, which also contributes to the design. In particular, we can efficiently generate valid system parameter values and thus facilitate the analysis of the configuration space properties. One property is about the distributions of configurations involving link interference. FIG. 35 shows the distribution of deformations involving link interferences (in dark gray) and deformations not involving link interferences (in light gray) of a spatial loop. Our method for this problem is effective and takes advantage of the stratified DSpace structures and simple triangle inequality constraints in our simplex-based parameters. With our effective approaches for systems allowing a tree construction from simplices, we make systems of this trait more attractive to designers, who will likely produce more systems of this trait.

As mentioned throughout this specification and illustrated by representative examples, our invention is very useful for many broad fields such as robotics, computational biology, mechanism design, foldable objects, and computer animation as well as simulation of the systems addressed in our invention.

Methods For Operating On System Configurations Using Simplex-Based Parameters

Our invention deals with multi-body systems having multipoint models allowing tree constructions from simplices, and a plurality of loops among the points. We process this type of systems, especially the complex ones such as that of the multi-fingered hand manipulation, as consisting of a hierarchy of subsystems and the interconnections among the sub-systems. A simple system can be considered of having one subsystem, which is also the original overall system. Regardless of the numbers of the subsystems and the levels of hierarchy, each sub-system also satisfies the specified properties including the existence of the tree constructions from simplices and can thus be efficiently dealt with in our approach. Also, for any system of the specified type, the existence of a construction tree of simplices for it means that its sub-systems, when each considered as a whole, also form a system with a tree structure, with each tree node for a subsystem and an edge between two nodes if two corresponding subsystems sharing some geometrical entities such as two tetrahedra sharing a face or two triangles sharing an edge. The tree of subsystems mean that there is no loop constraints on the relative configurations among the subsystems. Therefore, it is straightforward to specify the relative configuration parameters which are not subject to loop constraints, such as using angular or sign parameters for the relative orientations of two adjacent subsystems sharing points. Therefore, we can use simplex-based parameters, comprising the parameters for the subsystems individually as well as for relative configurations of subsystems, to effectively parameterizing and operating upon on the configurations the addressed systems.

Our Problem Parameters

FIG. 36 shows the basic steps of operations upon configurations of systems addressed in our invention, comprising specifying a construction tree of simplices 002 and specifying problem parameters 004. Again, the construction tree for a system generally consists of low-level trees for individual subsystems and high-level trees connecting the subsystems. For a given system, its overall construction tree may be supplied through an input file defining the tree or by users through some interactive input interface. It may also be automatically computed. As described earlier, there is no loop constraint among subsystems and they form high-level tree structure. Subsystems without loops can be naturally modeled as trees; and systems with loops have trees of simplices, as specified in the properties of the systems. So we can construct a tree of simplices for the overall system based on the low-level subsystem trees and the high-level inter-subsystem tree. For some systems, there might exist multiple choices for the construction tree, and different trees might have different properties for some problems. For example, FIG. 37 shows two different trees of anchored triangles for a 5-bar loop. The first tree uses joint P(0) as the anchor and leads to different orientation signs to the two loop deformations at the top of the figure. The second tree uses a different anchor and leads to a same orientation signs for the same two loop deformations, as shown at the bottom of the figure. From motion planning point of the view, the second tree would be convenient since both deformations are in the closure of one DSpace stratum. So among multiple choices of construction trees, one may be chosen randomly, or based on some criteria. It is also possible to use multiple trees or switch between trees for problem solving.

As for the parameters, they can be supplied or computed. The overall system parameters include parameters for subsystems as well as subsystem relative configurations. Their relative configuration parameters can be easily derived based on feasible relative motions among them and general motion parameters such as angles for relative rotations. Parameters for subsystems without loops can similarly be specified. For subsystems with loops, we use simplex-based approach as described early to define the parameters. In addition to loop constraints arising from the system structure requirement, some problems also impose other constraints and thus just need a subset of overall system parameters as problem parameters. For example, if a system is required to have its body frame at some specified configuration, then the problem parameters just need to be deformation parameters, without considering rigid motions. If some deformation parameters, such as some lengths, angles and/or orientation signs, are required to have certain specified value, those parameters become constants and do not have to be part of the problem parameters. If some parameters are required to maintain some equality relationship, such as having three side lengths of a triangle maintain certain singularity relationship like one being the sum of the other two, these constraints can also be used to reduce the number of problem parameters, or be used as the constraints on the parameters, without simplifying the problem parameters.

In FIG. 36, as well as subsequent flow chart figures, we use boxes drawn in dashed-double-dot lines to describe some example contexts of the described methods, but not as parts of the described methods. For systems addressed in our invention, we can further operate on configurations of the systems addressed in our invention, after the specification of a construction tree and problem parameters.

Parameter Conversion

One such operation is the conversion between other coordinate values and simplex-based parameter values of a system configuration. As an example, FIGS. 38 and 39 show the conversion between Cartesian coordinates and simplex-based coordinates. Conversion between simple-based parameters and other coordinates such as spherical and revolute joint angles can also be efficiently, possibly via intermediate Cartesian coordinates.

For specified point Cartesian coordinates, computing simplex-based problem parameter values 102 in FIG. 38 generally involves the computation of distances between points, angles between planes and lines, and/or some discrete orientation values such as the sign function of a matrix determinant, depending on the specific definitions of the simplex-based parameters. All these computation can be straightforwardly done using the basic teachings in analytic geometry, spatial geometry and vector algebra. The resulting simplex-based coordinate values can be further used in the operations upon the configuration based on our parameters.

For specified simplex-based parameter values of a multi-point configuration, computing point Cartesian coordinates is conceptually equivalent to putting the simplices properly in space, with the resulting system configuration having said simplex-based parameter values and point positions corresponding to their Cartesian coordinates. FIG. 39 shows one method for this task, comprising specifying a pose for a simplex in the construction tree 202 and then properly placing the rest of the simplices in the tree 204.

As for the choice of the first simplex to put down, in theory, any simplex in the tree will work. But there might be some preferences depending on problems. For example, for a problem requiring one simplex to assume certain specified configuration, it would be desirable to first put down that simplex at the required pose. But even for this case, it is fine to use any simplex as the first one to put down and then finish the placement of the rest of simplices. Afterward, we can use a rigid motion to move the whole system to make the specified simplex at the specified pose. This technique is particularly useful when a required configuration is specified for some points not belonging to one simplex in the construction tree under use. Another criterion for the selection of the first simplex could be to favor non-singular simplices over singular ones. As for a pose of the first simplex mentioned in block 202, the pose can be chosen randomly or based on some criteria. For example, we can put the first simplex at some convenient configuration such as having one vertex at the origin of a coordinate frame, and one edge passing that vertex at aligned with a coordinate axis, etc.

For the process of putting down the rest of simplices 204, we can consider the first placed simplex as the root and turn the construction tree into a rooted tree, which is a well-defined and well understood process in the graph theory. Then we can start to put down the child(ren) of the root, in any order if the root has multiple children. This is because each child shares some entities (such as edges or faces) with its parent and, with the shared entities already placed, the positions of other vertices of the child simplex can be computed based on the specified simplex-based parameter values, such as using the formula described in the part entitled “Parameter Conversion” for loop triangular parameters or the distance constraints for tetrahedral parameters. Clearly there is no requirement for the processing order of the child simplices. And after the placement of a child of the root, the children simplices of the placed child are ready to be processed. So in essence, in the rooted tree having the first placed simplex as the root, a simplex has to be placed before all its children and each simplex needs to be processed. This means that the rooted tree has to be traversed in any pre-order sequence, and we can use any pre-order tree traversal algorithm, such as breadth-first search, to generate such a sequence for the processing of the simplices.

The resulting Cartesian coordinates of the system configuration can be further used for many problems, such as evaluating the configuration for its singularity and collision properties, depicting the systems on computer screen, and further converting the Cartesian parameters to other parameters.

Generating Additional System Configurations from Some Given Ones

FIG. 40 shows another operation method upon system configuration, based on the simplex-based parameters, namely for generating additional system configurations from a set of specified configurations. The method comprises (a) computing the simplex-based parameter values of the specified configurations 302 and (b) generating additional configurations based on the parameter values of the specified configurations 304. Block 302 is self-explained; and readers can refer to our description above for FIG. 39 and reference therein for more information. So we will focus on block 304. As described earlier, one major advantage of operating upon the configurations of the systems addressed in our invention is the explicit and nice formulation of the system constraints in the simplex-based parameters as well as the structures of the set of feasible parameter values.

For example, we can take advantage of the convexity of the set of feasible diagonal lengths for the loop triangular parameters and use convex combinations of the diagonal length values of specified loops to generate more valid diagonal length values. FIG. 41 shows two sets of diagonal length values generated in the convex hull of specified diagonal values, the one on the left generated through random convex combination, and the other on the right by applying DeLaunay triangulation to the convex hull and than generate random samples in each triangle, with the sampling rate of a triangle being proportional to the ratio of its area over the overall area of the convex hull. Note that for a convex polytope with vertices q(i),i=1, . . . , n, a random sample in it can be found by generating arbitrary weight coefficients a(i)ε[0,1],i=1, . . . , n, satisfying

$${\sum }_{i = 1}^{n} = 1$$

and then computing

$$q = {\sum }_{i = 1}^{n} a ( i ) q ( i ) .$$

Also based on the uncoupling of length parameters and orientation parameters, we can generate more configurations just by changing the values of the orientation parameters for the non-singular simplices. We can also generate configurations by using other methods, such as optimization methods, gradient methods, Monte-Carlo simulation, Dynamics Simulation, random walk algorithms, etc, with proper definitions for the objective/evaluation functions of configurations, and possibly using the specified configurations as the starting points for the generation process.

System Constraint Formulation

FIG. 42 shows another system configuration operation method based on the simplex-based parameters, namely for formulating problem constraints in problem parameters. Our simplex-based problem parameters can effectively deal with many system constraints, comprising the loop constraints, constraints on the ranges of the link and diagonal lengths as well as the orientations and singularity of the simplices in the tree.

Range constraints on edge lengths and orientations of the simplices in the tree can be modeled as linear constraints if the range is not trivial, or as constant constraints if the range is trivial containing just one point. An empty range for one parameter makes the problem infeasible.

As described earlier for various example systems such as loops, polygonal cones and hand manipulation systems, we formulate the loop closure constraints as constraints on edge lengths required for successfully forming the simplices. This means that, the edge lengths of a triangle needs to satisfy the triangle inequality ((24)), and the edge lengths of a tetrahedron needs to satisfy the Cayley-Menger determinant constraint ((35)). To formulate the overall system constraints on the parameters, we just need to put together such constraints for all simplices, with each constraint in some equivalent form of the underlying simplex constraint. For example, two equivalent formulation of the triangle inequality constraint are given as the min/max formula ((26)) and the Cayley-Menger determinant constraint.

As for singular simplices in the tree, in general, we form each singularity constraint by replacing one or multiple inequality constraints on the simplex edge lengths with more restrictive equality constraints. Next we use triangular parameters as examples to illustrate our methods for parameterizing singular configurations, and apply the same approach to other simplices such as tetrahedral.

For the requirement of having triangle Tri([)T](j) in a construction tree T singular in some specified mode i, we restrict Ineq_{|T|(j)}ⁱ as defined in ((24)) to be equality. If triangle Tri([)T](j) is just required to be singular, but no specified singularity mode, we can formulate the constraint as requiring the Cayley-Menger determinant of the triangle to be zero, or equivalently, (at least) one of the equality holds. In other words, the feasible set of the side lengths of this triangle can be written in the following equivalent forms, where D(jᵢ, jₖ)=d²(jᵢ, jₖ) is squared distance between two triangle vertices.

$$\begin{matrix}\{ ( D ( {j}_{1} , {j}_{2} ) , D ( {j}_{2} , {j}_{3} ) , D ( {j}_{3} , {j}_{1} ) ) \vert CMD ( D ( {j}_{1} , {j}_{2} ) , D ( {j}_{2} , {j}_{3} ) , D ( {j}_{3} , {j}_{1} ) ) = 0 \} & ( 37 ) \\ {{⋃}^{3}}_{i = 1} \{ ( d ( {j}_{1} , {j}_{2} ) , d ( {j}_{2} , {j}_{3} ) , d ( {j}_{3} , {j}_{1} ) ) \vert ( d ( {j}_{1} , {j}_{2} ) , d ( {j}_{2} , {j}_{3} ) , d ( {j}_{3} , {j}_{1} ) ) satisfying {Eq}_{\vert T \vert ( j )}^{i} \} & ( 38 )\end{matrix}$$

In general, the constraint above is not a convex constraint and its corresponding feasibility set is not convex. For example, each pair of the parallel lines in DStretch(0) shown in FIG. 20 corresponds to singularity of one anchored triangle. Clearly, the union of two such line segments in the plane is not convex. For some special cases, the feasibility set for the constraint above becomes convex, for example when a specified triangle can only degenerate in one particular mode. Under all circumstances, the feasible set for the constraint above is the union of (possibly empty) convex sets as written as in (38), where each subset for the union operation is the feasible set for one particular singularity mode and is still convex.

These mathematically equivalent constraint formulations have different traits. For example, the Cayley-Menger determinant formulation (37) is compact. But its feasibility set is generally not convex, which has some drawbacks. For example, optimization problems involving this type of constraints generally cannot be solved using efficient convex programming methods. The union of singularity mode formulation (38) is less compact but also has its own advantages. For example, an optimization problem involving this constraint can be solved by decomposing the problem into multiple sub-problems with each problem involving one convex singularity mode constraint and, if other constraints are also convex, solve each sub-problem using convex optimization, followed by proper treatment of the results from the sub-problems.

If a problem requires multiple singular simplices, without specifying their singularity modes, we can use Cayley-Menger constraints for the simplices, or consider possible combinations of the simplex singularity modes, i.e., the system singularity patterns. Further Operations Involving System Constraints There are many possible operations over the formulations of system constraints in our simplex-based parameter values. We will just use a few example applications to illustrate our methods. We will first consider the computation of the topological and geometrical properties of the feasible parameter set for a constraint. The resulting topology and/or geometrical results can be used in many ways, for example, to guide motion planning algorithms, to evaluate some kinematics related system properties and even further improve the subsequent system design, to serve as concrete examples for robotics researchers and students to appreciate configuration spaces and the importance of parameterizations, and to help topology students see the connections between abstract concepts and physical systems.

There are many topological properties of a feasible parameter set for constraints under study, such as the number of connected components and relationships among the subsets of the overall feasible set like the subset adjacency and intersection relationships. As illustrated for loop singular parameters, construction of the topology of a set can be done using techniques developed in the topology community, such as boundary identification where the boundaries generally correspond to singular configurations in system parameters.

Another such operation is to compute the geometrical properties of the feasible set for the constraints. While there is much geometrical information associated with a feasible set, we will just use a few examples to illustrate our general techniques, taking advantage of the nice constraint formulations in our simplex-based parameters.

First, consider the vertices of a feasible set of length variables under the triangle inequality constraints, such as those diagonal and changeable link lengths used in a construction tree of triangles for loops. As described earlier, a feasible set of these length variables is generally a convex polyhedron, denoted by DStretch[T] in earlier description with T for the construction tree in use, and thus its vertices encode rich geometrical information of the set. Since these length variables are subject to linear triangle inequality constraints, they can be computed by finding all feasible basis solutions for the corresponding linear inequalities as well as other methods developed for linear systems and linear programming. After finding vertices of a convex polyhedron, we can generate any point inside the polyhedron by some convex combination of the vertices. For example, we can use the average of the vertices to find what we call the centroid point of the set. FIG. 43 illustrates DStretch[0] at the bottom-right subfigure and some system deformations of a 5-bar loop in other sub-figures, with the deformation diagonal lengths corresponding to the vertices and centroid of the DStretch[0] as highlighted by circles in the DStretch[0] subfigure.

Next consider computing the bounding box of a feasible set of length parameters. Based on the definition of bounding boxes, this amounts to computing the minimum and maximum values of each involved length parameter. So one way for computing these bounding values is to formulate the optimization problems, such as one shown below, and solve the problems with optimization algorithms.
minimize r[T](j)s.t.(l v̅, r̅[T])satisfying system constraints (39)
maximize r[T](j)s.t.(l v̅, r̅[T])satisfying system constraints (40)
Note that we can replace length parameters in the formulations above with squared lengths, when desirable, for example in dealing with Cayley-Menger determinant constraints of tetrahedra. Among various kinds of optimization problems, the so-called convex optimization problems, with convex objective functions over convex feasible sets and including linear programming and convex quadratic programming as subclasses, can be very efficiently solved. For our triangular inequality and tetrahedron Cayley-Menger determinant constraints, including those for singular simplices, the feasible length parameter sets are generally convex or unions of convex sets. So as long as objective functions are convex, we can use convex programming methods for solving our optimization problems. For example, for the above two problems, if the system constraints over the length parameters are convex, these two problems become convex programming problems, in fact also linear programming problems, and can thus be efficiently solved. If the feasible parameter set of the constraints can be modeled as unions of multiple convex subsets, then we can solve convex optimization problems for each convex subset and find its corresponding minimum and maximum parameters value, and then easily compute the minimum and maximum parameter values of the overall system by taking the minimum (maximum) of all minimum (maximum) parameter values of the subsets. Of course, optimization problems of this type can also be solved directly via general programming techniques.

Optimization algorithms generally return an optimal value for a specified objective function and one or more parameter values achieving the optimal objective value. By forming appropriate objective functions, optimization problems can be used to find parameter values of desired properties. For example, optimizations for the above two problems will generally also return diagonal lengths achieving the minimum or maximum value for some length variable. We can also formulate other types of objective functions. For example we can define a randomly weighted linear function, dot(w, [l v̅, r̅[T]]) where w is a random weight vector, for a random generation of valid length parameters.

Tree-Based Methods for Triangular Parameters

In addition to the optimization methods, we have also developed tree-based methods, taking advantage of the simplex construction trees of systems under study. For a multi-point system and a construction tree of triangles, we can define multiple rooted trees of diagonals, with each tree reflecting a particular set of choices of parent-child relationship among the diagonals and links.

There are many ways for constructing the diagonal trees, and we describe one example method here. For this method, we call a diagonal or a link visited if the diagonal or the link is already in a diagonal tree under construction. We call a triangle visited if all its three edges are put in a diagonal tree. Otherwise, the entities are called unvisited.

First pick a diagonal as a root, and assume that this diagonal appears in m triangles. Note that m is greater than or equal to 2. Without going to the method implementation details, let us treat this root as having m copies, with one copy for each triangle having the root diagonal as an edge. For each copy of this root node, make the other two edges of its corresponding triangle to be its children. In other words, this step visits all triangles having the root diagonal as an edge and put the unvisited edges of those triangles in the diagonal tree.

For the child nodes of the root, if a node corresponds to a link, the node becomes a leaf of the diagonal tree. If a child node of the root corresponds to a diagonal, then that diagonal belongs to at least 2 triangles, including one already visited due to the root diagonal. Assume one such diagonal belongs to m1 triangles. We treat this diagonal as having m1−1 copies, with each copy corresponding to one of the triangles having the diagonal as an edge except the one already visited due to its parent. In other words, each copy of a diagonal is for one unvisited triangle having the diagonal as an edge. Next we visit each of the unvisited triangles of the child nodes of the root and add unvisited edges of those triangles in the tree.

Repeat this process with the newly added nodes until all diagonals and links are put in the tree. FIG. 44 shows two diagonal trees for a same multiple body system, where each oval drawn in a solid line denotes a diagonal or link, and an oval drawn in a dashed line denotes a copy of the diagonal represented by the enclosing oval in the solid line.

We use diagonal trees for many efficient operations involving diagonals. As an example, consider the computation of the bounding box of the closure of a DStretch[T] stratum, with the stratum satisfying a specified singularity pattern. As described earlier, we can use optimization methods to solve this problem. Here we describe a diagonal tree based method, as shown in FIG. 45. At step 502, we use a post-order tree traversal order, such as one used in the depth-first search, to compute the partial diagonal ranges in a bottom-up fashion, with the range of a parent diagonal determined from those of its children. Note that the leaves of a diagonal tree are links with known ranges.

For the simplicity of the description, if a diagonal has multiple copies, we will call each copy a node in describing its relationship to its children, but with the understanding that all copies of one diagonal should have a consistent range eventually. We also treat each real diagonal as one node with respect to its parent, regardless of its numbers of copies relative to its children. Using this naming convention, each parent node has two children, all belonging to one triangle. So their lengths need to satisfy the triangle inequalities, as well as the constraints imposed by a required singularity mode for the triangle, if any. The range of a parent diagonal can be computed from those of its children's using interval arithmetics and taking into account the non-negative length constraint, triangle inequalities and singularity patterns.

Now suppose a diagonal r(j) has m copies, with each copy corresponding to a different triangle having the diagonal as an edge. Each copy is also the root of a subtree beneath the node. So the bottom-up computation of the diagonal ranges generally lead to different range intervals for different copies of the interval. Denote the minimum and maximum of the m copies of the diagonal by rblᵢ(j) and rbuᵢ(j), i=1, . . . , m. Then the range of this diagonal should be the intersection of the ranges of the multiple copies, and we can compute its bound values as follows.
rbl(j)=maxᵢ₌₁^{m}(rblᵢ(j)),rbu(j)=minᵢ₌₁^{m}(rbuᵢ(j)) (41)
These bound values are used as the range of this diagonal node, for example in the computation of the range of its parent and sibling diagonals.

Since the ranges of different copies of a diagonal are computed from different subtrees, there is no constraint between the ranges of the copies. So could happen that the minimum value of one copy is strictly larger than the maximum value of another copy. When this indeed happens, the above formula will assign a larger value to the minimum than the maximum. This contradiction means that the specified link length ranges are not feasible for forming one or more loop in the specified multi-point model, and thus the computation should stop.

For the clarity of the flow charts, we do not include this kind of test (like whether rbl(j)≦rbu(j)) and some test-result-dependent branches (such as “report error, exit”) in the figures, since those having ordinary skills in the art are capable of dealing with these cases. Our flow charts and specifications are devoted for the descriptions of the major cases and computation methods.

Now let us consider the case where the given link length ranges are feasible for forming the specified multi-point model. At the end of step 502, the root diagonal has its minimum and maximum values determined by the model. But each of the rest of the diagonals only has partial ranges, as determined by the subtree rooted at the diagonal and the corresponding sub-system of the multi-point system.

So at step 504, we use a pre-order tree traversal order (such as one used in breadth-first search) to update the diagonal ranges, in a top-down fashion, to take the whole multi-point system into account. Suppose for a diagonal r(j), its partial range at the end of step 502 is [rbl(j), rbu(j)]. At step 504, its range computation involves first computing another partial range as determined by the ranges of its parent and sibling, again with all three belonging to one triangle. Therefore, this step can be efficiently down, for example, by using the formula given earlier. Denote the so-computed partial range of r(j) by [rtl(j), rtu(j)]. Then the final range [rtl(j), rtu(j)] of this diagonal is the intersection of two partial intervals, i.e.
rl(j)=max(rbl(j),rtl(j)),ru(j)=min(rbu(j),rtu(j)) (42)

Note that if a diagonal has multiple copies (such as those drawn in dashed lines in FIG. 44), each copy should use the computed final range [rl(j), ru (j)] of the diagonal in the subsequent computation of the ranges of its child nodes.

Traversal of diagonal trees, with some computation along the process, is useful for many diagonal length related computation. The computation of diagonal length ranges as described above is one example illustrating this simple and effective approach. FIG. 46 shows another example for generating one value for length parameters (l v̅, r̅)satisfying a specified singularity pattern. Here we consider that a construction tree of diagonals and non-empty diagonal ranges satisfying the specified singularity pattern are supplied, for example, through user input or from some prior computation. The method works in a top-down fashion. At step 602, we specify a value for the root diagonal in its range interval. This value can be chosen randomly, or based on some specified criteria. For example, one criterion could be to define a Gaussian distribution over the interval and then pick a value randomly, with the possibly of a point being chosen determined by the specified Gaussian distribution.

In box 604, we use a pre-order traversal order to assign one value to each of the rest length parameters. For each parameter, we first update its range based on (a) its parent's length value, and (b) its sibling's length value, if already specified, or its sibling's range, otherwise, taking into account the specified singularity mode, if any, for the triangle. Then we specify a value for the diagonal in its updated range. Again, the value can be chosen randomly, or based on some specified criteria.

Path Planning Methods

Path planning problems of the systems addressed in our invention are grouped into two categories, distinguished by whether critical singular configurations need to be used for connecting a specified start configuration and a specified goal configuration. For two given configurations and a specified construction tree of simplices, if the parameters values of the two specified configurations include opposite sign values for some non-singular simplices, their connections need to go through singular configurations having those simplices at degenerate poses. As explained earlier, these singular configurations, if exist, have their length parameter values on some singular boundary sets joining pieces of appropriate sign labels.

If the start and goal configurations do not have any opposite sign values, they belong to the closure of one stratum and their path planning, for the constraints considered in this description, do not require going through singular configuration. As described earlier, the constraints consider in this description are those that can be efficiently encoded in simplex-based parameters, comprising loop closure constraints, link length ranges, as well as diagonal lengths, orientation parameters and singularity constraints on the simplices used in a construction tree.

FIG. 47 shows a method for planning a milestone path between a specified start configuration and a specified goal configuration, with the milestone path have its two ends at the start and goal configurations, and intermediate nodes, if any, being the critical singular configurations needed for connecting the two specified configurations. Such a milestone path has every two adjacent nodes in a closure of one stratum and can be further used to generate a detailed path.

We assume that a construction tree and a problem parameter set are already specified. Refer to the description of boxes 002 and 004 for related information. In box 702, the problem parameter values of the two specified configurations are computed, if not provided. This step generally involves conversion of the other parameter values of the two specified configurations to simplex-based parameter values. Refer to earlier description on parameter conversion and box 102 for more information. In box 704, we search for a set RST of the indices of simplices, each non-singular and having opposite orientation signs for two specified configurations. This step can be done by comparing the values of the sign parameters of the start and goal configurations. In box 706, we check if such a set is empty. If it is, it means that the two specified configuration belong to the closure of one stratum and that there is no need for critical singular configurations. So we just use the start and goal as the milestone nodes, in box 708.

If there are non-singular simplices with opposite orientation signs at the start and goal configurations, we try to generate a group of length parameter values needed for achieving the singularity at the RST simplices in box 710. Each length parameter value (l v̅, r̅) in this collection needs to be able to induce singularity to at least one simplex in the RST set. And the union of the singular simplices induced by the collection of the length parameter covers the RST simplices. As described earlier, the problem of finding a length parameter value achieving singularity at a specified set of simplices can be solved by various methods, such as using the optimization method with the problem constraint encoding the singularity as well as other relevant constraints such as triangle inequality and Cayley-Menger determinant constraint.

With that problem solved, we face another problem in this step, which is to determine how many length parameter values are to be included in a collection and how to assign the RST simplices to the collection members. This assignment problem can be addressed in many ways. For example, we can attempt to generate just one length parameter value that achieves singularity at all RST simplices. If the attempt is successful, we will have a milestone path that has only one intermediate singular configuration. If the attempt is not successful or if there is a preference not to do so, we can try other choices, for example by having the same number of the critical length parameter values as the number of simplices in the RST set and then letting each critical length parameter value try to be singular in just one RST simplex. Of course, other assignment schemes of the RST simplices to critical length parameter values are possible. Unless there are restrictions to assignment schemes, we can enumeratively try all assignment schemes until one is successful or determining none exists, which means that some simplices in the RST set cannot become singular.

If there are many motion planning problems to be solved for a particular system, it would be helpful to identify the set of never-singular simplices, each one of them impossible to become singular at all, in some processing step. Then for each specified motion planning problem, we check if any one of those never-singular simplices is listed in the RST set. If and only if at least one of those never-singular simplices is listed in the RST set, no path exists.

If a system has no never-singular simplex, then the configuration of the system is connected and there is a path between any two configurations. One such example system is a planar loop that does not have 3 long links. For a loop with fixed link lengths, if the sum of the second-longest link length and the third-longest link length is strictly greater than the sum of the lengths of all other links, the loop has 3 long links. Otherwise, it does not have 3 long links.

A planar loop with 3 long links has only one never-singular triangle. Note that, for any triangle in a construction tree for a loop, each edge of the triangle shares its two end points with an open chain of loop links, which will be called the corresponding link chain of the edge. For a specified construction tree of a loop with 3 long links, this never-singular triangle is the triangle in the tree satisfying the property that each of the triangle edges has one and only one of the top-3 longest links in its corresponding link chain.

If the attempt in box 710 is unsuccessful, we report in box 712 that no path exists.

Otherwise, in box 714, we generate a sequence of orientation sign values to be paired with the critical length values for the critical intermediate nodes of a milestone paths. If no other constraints or objectives (such as minimizing path lengths) are considered, we can use these critical length values in any order. This means that for a set of m critical length values, we can use them in m! orders, which lead to different but related subgoals and milestone paths. When more constraints and/or objectives are considered, some orders will be better than others.

Assuming that an order is specified based on some criteria, for example through user selection or some computation process, we need to generate appropriate sign values for the critical intermediate configurations and the piece-wise path, with each piece between two adjacent milestone nodes being in the closure of one stratum and having one sign value. One way for doing this is as follows. Use the sign value of the start configuration as the sign for the first path piece between the start and first intermediate configurations. Then for the first intermediate configuration, assign 0 to all its singular simplices and let all other simplices to have the same signs of the corresponding simplices in the path piece right before it. And for the path piece after the first intermediate configuration, let all the simplices singular at the first intermediate configuration to have the sign values of the corresponding simplices at the goal configuration, and still let all other simplices to have the same values of the corresponding simplices at the intermediate configuration. Continue this process to all intermediate configurations until the goal configuration.

FIG. 48 shows two milestone paths for a same pair of deformations of a planar 5R loop. The two milestone paths uses same two critical r̅(0) values, but in different orders. The path in FIG. 48A first goes to a triangle deformation (with its r̅[a] value corresponding to a DStretch(0) vertex) while the path in FIG. 48B uses the triangle deformation as the second milestone. The table in FIG. 48C summarizes the s[a] values for the two paths.

After a milestone path is found, it might be needed or desirable to generate a detailed path. Since every two adjacent configurations in a milestone path belong to the closure of one stratum, generation of a detailed path for the original problem amounts to generating a sequence of detailed paths in a sequence of closures of strata, with one detailed path between two adjacent milestone configurations in each stratum closure. We can use many methods for generating a detailed path between two configurations belonging to the closure of strata, such as the cell decomposition methods, roadmap methods, potential-field methods, random walk, and sampling based methods like probabilistic roadmap methods and rapidly-exploring random tree methods. Explicit and efficient formulation of the system constraints in our simplex-based parameters can further improve the efficiency of these methods when applied to the systems addressed in this description. We should also take advantage of the nice configuration space structures under our parameterization. For example, path planning for two configurations of a spatial loop, even when all link lengths are changeable, can be very efficiently done since linear interpolation between their simplex-based parameter values is a valid straight line path between the two configurations.

Broad Applicability of the Invention

Although the invention has been described with reference to these preferred methods, other methods can achieve the same results. Variations and modifications of the present invention will be obvious to those skilled in the art and it is intended to cover in the appended claims all such modifications and equivalents.

We claim:

1. A method for efficient operations upon configurations of a multi-body system with a multi-point model allowing a tree construction from simplices and a plurality of loops among the points, comprising:
(a) specifying a construction tree of simplices for said multi-point system;
(b) specifying a set of problem parameters as a subset of configuration parameters of said multi-body system, said configuration parameters comprising base configuration parameters and simplex-related parameters, said simplex-related parameters comprising length parameters needed for determining the geometries of said simplices and relative configuration parameters for each pair of adjacent said simplices in said construction tree, said specified set of problem parameters including at least one simplex-related parameter,
whereby operations upon configurations of said multipoint system are done in an efficient fashion in terms of said problem parameters.

2. The method of claim 1 wherein said construction tree of simplices is supplied.

3. The method of claim 1 wherein said construction tree of simplices is automatically generated.

4. The method of claim 1 wherein said construction tree of simplices is selected to optimize a given figure of merit.

5. The method of claim 1 wherein said specified set of problem parameters is the complete set of system configuration parameters.

6. The method of claim 1 The method of claim 1 wherein said specified set of problem parameters is the set of simplex-related parameters.

7. The method of claim 1, further comprising the step of computing the values of said problem parameters for a specified configuration of said multi-point model.

8. The method of claim 7, further comprising the step of evaluating, upon said specified configuration, a plurality of given figure of merit functions, said given figure of merit functions including among their variables subsets of said values of said problem parameters.

9. The method of claim 1, further comprising the step of computing values of other coordinates of a configuration of said multi-point model having a specified value for said problem parameters.

10. The method of claim 9 wherein said computation is done in a tree-based simplex placement procedure.

11. The method of claim 9, further comprising the step of evaluating, upon said specified configuration, a plurality of given figure of merit functions, said given figure of merit functions including among their variables subsets of said computed values of said other coordinates of said specified configuration.

12. The method of claim 1
(a) computing values of said problem parameters for a plurality of specified configurations of said multi-point model, if said values of said problem parameters of said specified configurations are not specified;
(b) generating values of said problem parameters for a plurality of system configurations derived from said specified configurations.

13. The method of claim 12 wherein said values of said problem parameters for said derived system configurations are generated by means of a plurality of algorithms comprising convex combination, orientation modification algorithms, optimization algorithms, gradient algorithms, monte carlo simulation algorithms, dynamics simulation algorithms, random walk, and seed-based sampling algorithms.

14. The method of claim 1, further comprising the step of formulating system constraints in problem parameters, whereby operations upon configurations of said multi-point model satisfying said system constraints can be efficiently done in said problem parameters.

15. The method of claim 14, wherein said system constraints comprise constraints in said length parameters for successful formation of said simplices.

16. The method of claim 14, wherein said system constraints comprise constraints in said length parameters for specified geometries of said simplices.

17. The method of claim 14, further comprising the step of computing specified properties of the set of feasible values for said problem parameters satisfying said system constraints.

18. The method of claim 17, wherein said specified properties comprise topological properties.

19. The method of claim 17, wherein said specified properties comprise geometrical properties.

20. The method of claim 17, wherein said specified properties comprise properties of the set of feasible values of said length parameters satisfying said system constraints.

21. The method of claim 17, further comprising the step of generating a plurality of feasible values for a subset of said problem parameters satisfying said system constraints.

22. The method of claim 14, further comprising the step of generating a plurality of feasible values for a subset of said problem parameters satisfying said system constraints.

23. The method of claim 22, wherein said subset of said problem parameters comprises length parameters.

24. The method of claim 22, wherein said feasible values for said subset of said problem parameters satisfying said system constraints are computed by means of a plurality of algorithms including but not limited to optimization methods and tree-based methods.

25. The method of claim 1, wherein all said simplices in said construction tree are triangles, and further comprising the step of computing a plurality of feasible values for said subset of said problem parameters satisfying specified system constraints by a tree-based method.

26. The method of claim 1, further comprising the step of computing the values of said problem parameters for a specified start configuration and a specified goal configuration of said multi-point model, if said values of said problem parameters for said start and goal configurations are not specified, attempting to plan a plurality of paths between said start configuration and said goal configuration, using said values of said problem parameters for said start and goal configurations.

27. The method of claim 26, wherein said values of said problem parameters for said start and goal configurations belong to the closure of one stratum of the set of feasible values of said problem parameters under specified system constraints.

28. The method of claim 27, wherein a plurality of paths between said star configuration and said goal configuration is attempted to be generated by means of a plurality of algorithms comprising linear interpolation, roadmap methods, cell-decomposition methods, potential field methods, sampling based methods, probabilistic roadmap methods and rapidly-exploring random tree methods.

29. The method of claim 26, wherein said values of said problem parameters for said start and goal configurations do not belong to the closure of one stratum of the set of feasible values of said problem parameters under specified system constraints.

30. The method of claim 29, further comprising the step of attempting to specify a sequence of the values of said problem parameters for critical singular configurations, whereby a milestone path formed by said start configuration and said goal configuration at the two ends and said sequence of critical singular configuration in the middle satisfies the property that each two adjacent nodes in said milestone path belong to the closure of one stratum of the set of feasible values of said problem parameters under said specified system constraints.

31. The method of claim 30, wherein said values of said problem parameters of said critical singular configurations are selected from a specified set of values of said problem parameters of singular configurations.

32. The method of claim 30, wherein said values of said problem parameters of said critical singular configurations are automatically computed.

33. The method of claim 30, further comprising the step of attempting to plan a detailed path between said start configuration and said goal configuration based on said milestone path.

34. An apparatus for operating upon configurations of a multi-body system with a multi-point model allowing a tree construction from simplices and a plurality of loops among the points, said apparatus comprising
(a) means for specifying a construction tree of simplices for said multi-point system;
(b) means for specifying a set of problem parameters as a subset of configuration parameters of said multi-body system, said configuration parameters comprising base configuration parameters and simplex-related parameters, said simplex-related parameters comprising length parameters needed for determining the geometries of said simplices and relative configuration parameters for each pair of adjacent said simplices in said construction tree, said specified set of problem parameters includes at least one simplex-related parameters.

35. The apparatus of claim 34 wherein said means for specifying said construction tree comprises means for receiving supplied specification of said construction tree.

36. The apparatus of claim 34 wherein said means for specifying said construction tree comprises means for automatically generating said construction tree.

37. The apparatus of claim 34 wherein said means for specifying said construction tree comprises means for selecting said construction tree to optimize a specified figure of merit.

38. The apparatus of claim 34 wherein said means for specifying said problem parameters comprises means for specifying the complete set of system configuration parameters.

39. The apparatus of claim 34 wherein said means for specifying said problem parameters comprises means for specifying the set of simplex-related parameters.

40. The apparatus of claim 34, further comprising means for computing the values of said problem parameters for a specified configuration of said multi-point model.

41. The apparatus of claim 40, further comprising means for evaluating, upon said given configuration, a plurality of given figure of merit functions, said given figure of merit functions including among their variables subsets of said values of said problem parameters.

42. The apparatus of claim 34, further comprising means for computing values of other coordinates of a configuration of said multi-point model.having a specified value for said problem parameters.

43. The apparatus of claim 42, wherein said means for computing values of said other coordinates of said configuration of said multi-point model having said specified value for said problem parameters comprises means for computing said values in a tree-based simplex placement procedure.

44. The apparatus of claim 42, further comprising means for evaluating, upon said specified configuration, a plurality of given figure of merit functions, said given figure of merit functions including among their variables subsets of said computed values of said other coordinates of said specified configuration.

45. The apparatus of claim 34
(a) means for computing values of said problem parameters for a plurality of specified configurations of said multi-point model, if said values of said problem parameters of said specified configurations are not specified;
(b) means for generating values of said problem parameters for a plurality of system configurations derived from said specified configurations.

46. The apparatus of claim 45, wherein said means for computing said values of said problem parameters for said derived system configurations comprises means for computing these means using a plurality of algorithms comprising convex combination, orientation modification algorithms, optimization algorithms, gradient algorithms, monte carlo simulation algorithms, dynamics simulation algorithms, random walk, and seed-based sampling algorithms.

47. The apparatus of claim 34, further comprising means for formulating specified system constraints in problem parameters, whereby operations upon configurations of said multi-point model satisfying said system constraints can be efficiently done in said problem parameters.

48. The apparatus of claim 47, wherein means for formulating specified system constraints comprises means for formulating constraints in said length parameters for successful formation of said simplices.

49. The apparatus of claim 47, wherein means for formulating specified system constraints comprises means for formulating constraints in said length parameters for specified geometries of said simplices.

50. The apparatus of claim 47, further comprising means for computing specified properties of the set of feasible values for said problem parameters satisfying said system constraints.

51. The apparatus of claim 50, wherein said means for computing said specified properties comprises means for computing topological properties.

52. The apparatus of claim 50, wherein said means for computing said specified properties comprises means for computing geometrical properties.

53. The apparatus of claim 50, wherein said means for computing said specified properties comprises means for computing properties of the set of feasible values of said length parameters satisfying said system constraints.

54. The apparatus of claim 50, wherein said means for computing said specified properties comprises means for computing said specified properties using a plurality of algorithms comprising to topology construction methods, boundary identification methods, optimization methods and tree-based methods.

55. The apparatus of claim 47, further comprising means for generating a plurality of feasible values for a subset of said problem parameters satisfying said system constraints.

56. The apparatus of claim 55, wherein said means for generating a plurality of feasible values for a subset of said problem parameters satisfying said system constraints comprises means for generating a plurality of feasible values for length parameters satisfying said system constraints.

57. The apparatus of claim 55, wherein said means for generating a plurality of feasible values for a subset of said problem parameters satisfying said system constraints comprises means for computing said feasible values of said subset of said problem parameters satisfying said system constraints using a plurality of algorithms comprising optimization methods and tree-based methods.

58. The apparatus of claim 34, wherein said means for specifying a construction tree of simplices comprises means for specifying a construction tree of triangles, and further comprises means for computing a plurality of feasible values for said subset of said problem parameters satisfying specified system constraints by a tree-based method.

59. The apparatus of claim 34, further comprising
(a) means for computing the values of said problem parameters for a specified start configuration and a specified goal configuration of said multi-point model, if said values of said problem parameters for said start and goal configurations are not specified,
(b) means for attempting to plan a plurality of paths between said start configuration and said goal configuration, using said values of said problem parameters for said start and goal configurations.

60. The apparatus of claim 59, wherein said means for attempting to plan a plurality of paths between said start configuration and said goal configuration, using said values of said problem parameters for said start and goal configurations, comprises means for attempting to generate a plurality of path between two configurations belonging to the closure of one strata by using a plurality of algorithms comprising linear interpolation, roadmap methods, cell-decomposition methods, potential field methods, sampling based methods, probabilistic roadmap methods and rapidly-exploring random tree methods.

61. The apparatus of claim 59, wherein said means for attempting to plan a plurality of paths between said start configuration and said goal configuration, using said values of said problem parameters for said start and goal configurations, comprises means for attempting to specifying a sequence of the values of said problem parameters for critical singular configurations, whereby a milestone path formed by said start configuration and said goal configuration at the two ends and said sequence of critical singular configuration in the middle satisfies the property that each two adjacent nodes in said milestone path belong to the closure of one stratum of the set of feasible values of said problem parameters under said specified system constraints.

62. The apparatus of claim 61, wherein said means for attempting to specifying a sequence of the values of said problem parameters for critical singular configurations comprises means for attempting to select said critical values from a specified set of values of said problem parameters of singular configurations.

63. The apparatus of claim 61, wherein said means for attempting to specifying a sequence of the values of said problem parameters for critical singular configurations comprises means for attempting to automatically compute said critical values.

64. The apparatus of claim 63, further comprising means for attempting to plan a detailed path between said start configuration and said goal configuration based on said milestone path.
